(19) United States
(12) Patent Application Publication
(10) Pub. No.: US 2025/0200967 A1
(43) Pub. Date: Jun. 19, 2025

(54) ELECTRONIC DEVICE AND METHOD FOR IDENTIFYING OBJECT IN VIDEO

(71) Applicant: THINKWARE CORPORATION, Seongnam-si (KR)

(72) Inventors: Yechan Choi, Seongnam-si (KR); Yosep Park, Seongnam-si (KR)

(73) Assignee: THINKWARE CORPORATION, Seongnam-si (KR)

(21) Appl. No.: 18/978,491

(22) Filed: Dec. 12, 2024

(30) Foreign Application Priority Data
Dec. 14, 2023 (KR) 10-2023-0182492

(51) Int. Cl. G06V 20/40; G06F 3/0346

(52) U.S. Cl. CPC G06V 20/40; G06F 3/0346

(57) ABSTRACT

According to an embodiment, an electronic device includes at least one camera, a gyro sensor, memory, and at least one processor operably connected with the at least one camera, the gyro sensor, and the memory, and the processor is configured to obtain video information by using the at least one camera, based on obtaining the video information, obtain, first rotation data on the electronic device by using the gyro sensor, and second rotation data by using a designated estimation model, based on the first rotation data and the second rotation data, obtain a rotation value for the video information, and based on the obtained rotation value, identify at least one object regarding the video information.

### CROSS-REFERENCE TO RELATED APPLICATION(S)

This application is based on and claims priority under 35 U.S.C. § 119 to Korean Patent Application No. 10-2023-0182492, filed on Dec. 14, 2023, in the Korean Intellectual Property Office, the disclosure of which is incorporated by reference herein in its entirety.

### BACKGROUND

### Technical Field

The present disclosure relates to an electronic device and a method for identifying an object in a video.

### Description of Related Art

An electronic device may obtain a video. The electronic device may identify an object in the obtained video. However, when the video is obtained in a state that the electronic device is rotated, the electronic device may not identify the object as the rotated object is included in the obtained video.

The above-described information may be provided as a related art for the purpose of helping understanding of the present disclosure. No argument or decision is made as to whether any of the above description may be applied as a prior art related to the present disclosure.

### SUMMARY

According to an embodiment, an electronic device may comprise at least one camera, a gyro sensor, memory, and at least one processor operably connected with the at least one camera, the gyro sensor, and the memory, and the processor may be configured to obtain video information by using the at least one camera, based on obtaining the video information, obtain, first rotation data on the electronic device by using the gyro sensor, and second rotation data by using a designated estimation model, based on the first rotation data and the second rotation data, obtain a rotation value for the video information, and based on the obtained rotation value, identify at least one object regarding the video information.

According to an embodiment, a method of an electronic device may comprise obtaining video information by using at least one camera of the electronic device, based on obtaining the video information, obtaining, first rotation data on the electronic device by using a gyro sensor of the electronic device, and second rotation data by using a designated estimation model, based on the first rotation data and the second rotation data, obtaining a rotation value for the video information, and based on the obtained rotation value, identifying at least one object regarding the video information.

### BRIEF DESCRIPTION OF THE DRAWINGS

The above and other aspects, features, and advantages of certain embodiments of the disclosure will be more apparent from the following description, taken in conjunction with the accompanying, in which:

FIG. 1 illustrates an example of an electronic device for rotating a video according to an embodiment.

FIG. 2 illustrates an example of a block diagram of an electronic device according to an embodiment.

FIG. 3 is an exemplary flowchart for explaining an operation of an electronic device according to an embodiment.

FIG. 4 illustrates an example of an operation of an electronic device according to an embodiment.

FIG. 5A illustrates an example of a value obtained through an acceleration sensor according to an embodiment.

FIG. 5B illustrates an example of an operation of an electronic device according to an embodiment.

FIG. 6A is an exemplary flowchart for explaining an operation of an electronic device according to an embodiment.

FIG. 6B illustrates an example of a designated estimation model according to an embodiment.

FIG. 7 illustrates an example of training data of a designated estimation model according to an embodiment.

FIG. 8A illustrates an example of an operation of an electronic device according to an embodiment.

FIG. 8B illustrates an example of an operation of an electronic device according to an embodiment.

FIG. 9 illustrates an example of an operation of an electronic device according to an embodiment.

FIG. 10A illustrates an example of an operation of an electronic device according to an embodiment.

FIG. 10B illustrates an example of an operation of an electronic device according to an embodiment.

FIG. 11 illustrates an example of an operation of an electronic device according to an embodiment.

FIG. 12 illustrates an example of a block diagram illustrating an autonomous driving system of a vehicle according to an embodiment.

FIGS. 13 and 14 illustrate an example of a block diagram indicating an autonomous moving object according to an embodiment.

FIG. 15 illustrates an example of a gateway associated with a user device according to various embodiments.

FIG. 16 is a block diagram of an electronic device according to an embodiment.

### DETAILED DESCRIPTION

An electronic device according to an embodiment can identify an object based on a rotation value of a video. The electronic device can display the video in which a bounding box is displayed, superimposed on the identified object.

Hereinafter, embodiments of the present document will be described with reference to the attached drawings. With respect to the description of the drawing, a similar reference numeral may be used for similar or related components.

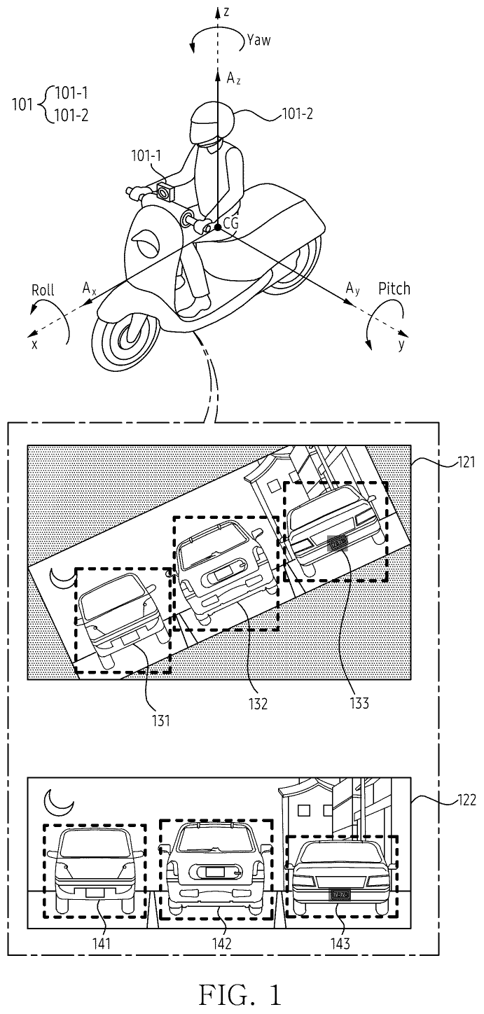

FIG. 1 illustrates an example of an electronic device for rotating a video according to an embodiment.

Referring to FIG. 1, an electronic device 101 may be configured based on various shapes. For example, the electronic device 101 may include an electronic device 101-1. The electronic device 101 may be configured with the electronic device 101-1. The electronic device 101-1 may correspond to a device (e.g., a black box) attached to a vehicle 110 (e.g., a motorcycle), or may be included in the device. According to an embodiment, the electronic device 101-1 may correspond to an electronic control unit (ECU) in the vehicle 110 or may be included in the ECU. The ECU may be referred to as an electronic control module (ECM). The electronic device 101-1 may be configured as independent hardware for a purpose of providing a function according to an embodiment of the present invention in the vehicle 110. For example, the electronic device 101 may include an electronic device 101-2. The electronic device 101 may be configured with the electronic device 101-2. The electronic device 101-2 may be wearable to a user of the electronic device 101-2. The electronic device 101-2 may be used to provide information to the user while being worn by the user.

Hereinafter, an operation of the electronic device 101 including the electronic device 101-1 and the electronic device 101-2 will be described.

According to an embodiment, the electronic device 101 may include a camera positioned toward a direction of the vehicle 110. FIG. 1 illustrates that electronic device 101 (or the camera included in the electronic device 101) is disposed toward a front direction (and/or a driving direction) of the vehicle 110, but is not limited thereto. For example, the electronic device 101 may be disposed toward at least one of a rear direction or a side direction of the vehicle 110.

According to an embodiment, the electronic device 101 may obtain a video 121 with respect to an external vehicle through the camera. The video 121 may be rotated according to rotation of the vehicle 110 or the electronic device 101. Hereinafter, for convenience of description, it will be described that a rotation value of the electronic device 101 corresponds to a rotation value of the vehicle 110. This is only for the convenience of the description, and the rotation value of the electronic device 101 may be different from the rotation value of the vehicle 110.

For example, the vehicle 110 may rotate relative to three axes (e.g., an x-axis, a y-axis, and a z-axis). An order and a direction of the illustrated three axes may be changed according to an embodiment. Rotation with respect to each of the three axes may be defined as a roll, a pitch, and yaw. Rotation with respect to the x-axis may be defined as the roll. Rotation with respect to the y-axis may be defined as the pitch. Rotation with respect to the z-axis may be defined as the yaw.

An axis may face the front direction of the vehicle 110. Since the camera of the electronic device 101 also faces the front direction of the vehicle 110, a video obtained through the camera of the electronic device 101 may be rotated according to the rotation with respect to the x-axis.

As an example, the electronic device 101 may obtain the video 121. The video 121 may be rotated based on a rotation value with respect to the roll of the vehicle 110 (or the electronic device 101). For example, an object 131, an object 132, and an object 133 included in the video 121 may be rotated based on the rotation value with respect to the roll of the vehicle 110 (or the electronic device 101). As the object 131, the object 132, and the object 133 are rotated, the electronic device 101 may not recognize the object 131, the object 132, and the object 133. For example, a bounding box for recognizing an object may be set large for the object (e.g., the object 131, the object 132, and the object 133). As the bounding box is set large for the object, an error in object recognition, or distance estimation with respect to a real object for the object may increase.

Therefore, the electronic device 101 may rotate the video 121 based on the rotation value with respect to the roll of the vehicle 110 (or the electronic device 101). The electronic device 101 may identify a video 122 by rotating the video 121 based on the rotation value with respect to the roll of the vehicle 110 (or the electronic device 101). The video 122 may include an object 141, an object 142, and an object 143. As the video 121 is rotated, the object 131 may be changed to the object 141. As the video 121 is rotated, the object 132 may be changed to the object 142. As the video 121 is rotated, the object 133 may be changed to the object 143.

The video 122 may be a video obtained in a state in which the vehicle 110 (or the electronic device 101) is not rotated. Therefore, the electronic device 101 may smoothly recognize the object 141, the object 142, and the object 143.

As in the above-described embodiment, technical features for rotating a video based on a rotation value with respect to the video (or video information) and recognizing an object through the rotated video will be described below.

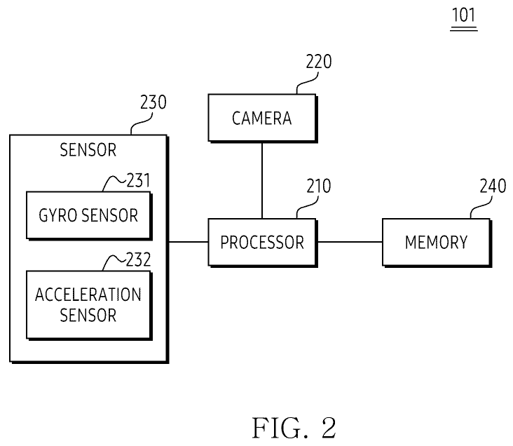

FIG. 2 illustrates an example of a block diagram of an electronic device according to an embodiment. An electronic device 101 of FIG. 2 may correspond to the electronic device 101 of FIG. 1.

Referring to FIG. 2, the electronic device 101 may include at least one of a processor 210, a camera 220, a sensor 230, or a memory 240. The processor 210, the camera 220, the sensor 230, and the memory 240 may be electronically and/or operably coupled with each other by an electronical component such as a communication bus. Hereinafter, devices and/or circuits being operably coupled may mean that a direct connection or an indirect connection between the devices and/or the circuits is established by wire or wirelessly so that a second circuit and/or a second device is controlled by a first circuit and/or a first device. Although illustrated in different blocks, an embodiment is not limited thereto. A portion of hardware of FIG. 2 may be included in a single integrated circuit such as a system on a chip (SoC). A type and/or the number of the hardware included in the electronic device 101 is not limited as illustrated in FIG. 2. For example, the electronic device 101 may include only a portion of the hardware illustrated in FIG. 2.

According to an embodiment, the electronic device 101 may include hardware for processing data based on one or more instructions. The hardware for processing data may include the processor 210. For example, the hardware for processing data may include an arithmetic and logic unit (ALU), a floating point unit (FPU), a field programmable gate array (FPGA), a central processing unit (CPU), and/or an application processor (AP). The processor 210 may have a structure of a single-core processor, or may have a structure of a multi-core processor such as a dual core, a quad core, a hexa core, or an octa core.

According to an embodiment, the camera 220 of the electronic device 101 may include a lens assembly or an image sensor. The lens assembly may collect light emitted from a subject which is a target of image photographing. The lens assembly may include one or more lenses. According to an embodiment, the camera 220 may include a plurality of lens assemblies. For example, a portion of the plurality of lens assemblies may have the same lens attributes (e.g., an angle of a view, focal length, autofocus, a f number, or an optical zoom), or at least one lens assembly may have one or more lens attributes different from lens attributes of another lens assembly. The lens attributes may be referred to as an intrinsic parameter for the camera 220. The intrinsic parameters may be stored in the memory 240 of the electronic device 101.

In an embodiment, the lens assembly may include a wide-angle lens or a telephoto lens. According to an embodiment, a flash may include one or more light emitting diodes (e.g., a red-green-blue (RGB) LED, a white LED, an infrared LED, or an ultraviolet LED), or a xenon lamp. For example, an image sensor in the camera 220 may obtain an image corresponding to a subject by converting light emitted or reflected from the subject and transmitted through the lens assembly into an electrical signal. According to an embodiment, the image sensor may include, for example, one image sensor selected from among image sensors with a different attribute, such as an RGB sensor, a black and white (BW) sensor, an IR sensor, or a UV sensor, a plurality of image sensors with the same attribute, or a plurality of image sensors with a different attribute. Each image sensor included in the image sensor may be implemented by using, for example, a charged coupled device (CCD) sensor or a complementary metal oxide semiconductor (CMOS) sensor.

According to an embodiment, the sensor 230 of the electronic device 101 may be used to obtain various external information. The sensor 230 may include a gyro sensor 231 and an acceleration sensor 232. For example, the gyro sensor 231 may identify (or measure, detect) an angular velocity of the electronic device 101 in three directions of an x-axis, a y-axis, and a z-axis. For example, the acceleration sensor 232 may identify (or measure, detect) acceleration of the electronic device 101 in the three directions of the x-axis, the y-axis, and the z-axis.

According to an embodiment, the memory 240 of the electronic device 101 may include a hardware component for storing data and/or an instruction inputted and/or outputted to the processor 210 of the electronic device 101. For example, the memory 240 may include a volatile memory such as random-access memory (RAM) and/or a non-volatile memory such as a read-only memory (ROM). For example, the volatile memory may include at least one of dynamic RAM (DRAM), static RAM (SRAM), Cache RAM, and pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disc, a solid state drive (SSD), and an embedded multi-media card (eMMC).

Although not illustrated, the electronic device 101 may further include various components. For example, the electronic device 101 may further include a display for displaying a user interface.

According to an embodiment, the electronic device 101 may include a neural network. For example, the neural network may include a mathematical model for a neural activity of a living organism related to reasoning and/or perception, and/or hardware (e.g., a CPU, a graphic processing unit (GPU), and/or a neural processing unit (NPU)), software, or any combination thereof for driving the mathematical model. The neural network may be based on a convolutional natural network (CNN) and/or long-short term memory (LSTM).

For example, the electronic device 101 may include (or store) a designated estimation model indicated by a plurality of parameters based on the neural network. The electronic device 101 may obtain rotation data by using the designated estimation model. For example, the electronic device 101 may set video information as input data of the designated estimation model. The electronic device 101 may obtain the rotation data based on output data of the designated estimation model.

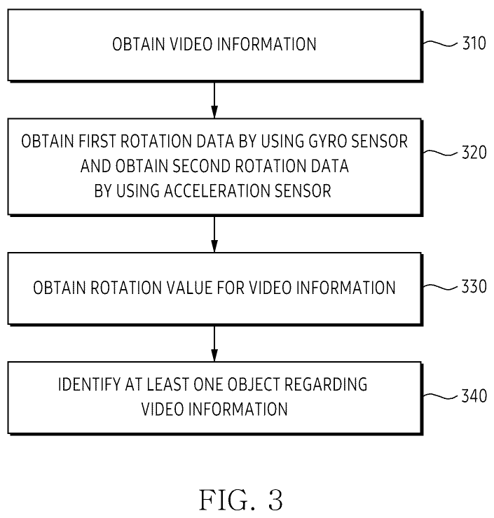

According to an embodiment, the electronic device 101 may obtain a rotation value for the video information obtained using the camera 220 by using the gyro sensor 231 and the acceleration sensor 232. The electronic device 101 may identify at least one object for the video information based on the obtained rotation value. An example of an operation of the electronic device 101 for obtaining the rotation value for the video information using the gyro sensor 231 and the acceleration sensor 232 will be described later in FIG. 3 to FIG. 5B.

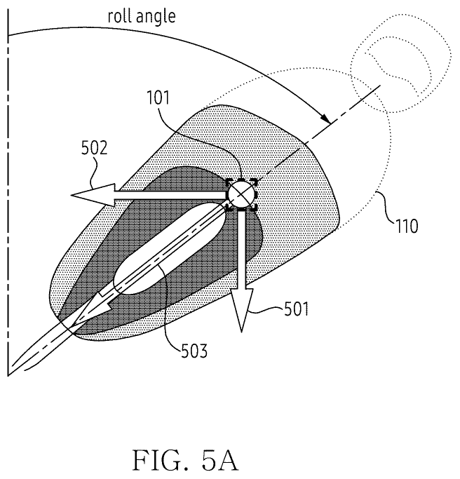

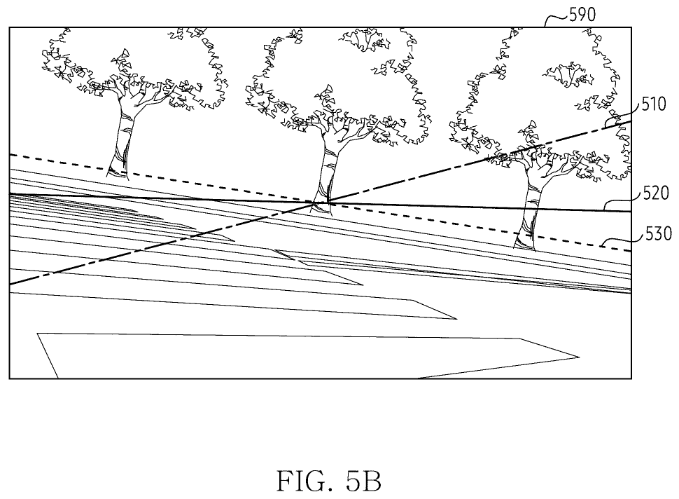

According to an embodiment, the electronic device 101 may obtain the rotation value for the video information obtained using the camera 220 by using the gyro sensor 231 and the designated estimation model. The electronic device 101 may identify the at least one object for the video information based on the obtained rotation value. An example of an operation of the electronic device 101 for obtaining the rotation value for the video information using the gyro sensor 231 and the designated estimation model will be described later in FIG. 5 to FIG. 10B.

FIG. 3 is an exemplary flowchart for explaining an operation of an electronic device according to an embodiment. The electronic device 101 and/or the processor 210 of FIG. 2 may perform at least one of operations of FIG. 3. In an embodiment, a computer readable storage medium may be provided, including a software application and/or instructions that cause the electronic device 101 and/or the processor 210 to perform the operations of FIG. 3.

Referring to FIG. 3, in an operation 310, the processor 210 may obtain video information. For example, the electronic device 101 may be moved together with a vehicle 110. While the electronic device 101 moves together with the vehicle 110, the video information may be obtained by using the camera 220 facing a front direction of the vehicle 110. A first video according to the video information may be rotated based on a rotation value (e.g., a rotation value with respect to a roll) of the vehicle 110.

In an operation 320, the processor 210 may obtain first rotation data by using a gyro sensor 231 and obtain second rotation data by using an acceleration sensor 232.

According to an embodiment, the processor 210 may obtain the first rotation data by using the gyro sensor 231. Based on the three axes illustrated in FIG. 1, the processor 210 may obtain a first angular velocity \vec{Ω_{X}}, a second angular velocity \vec{ΩY}, and a third angular velocity \vec{ΩZ} by using the gyro sensor 231. The first angular velocity \vec{Ω_{X}} may be an angular velocity with respect to an x-axis. The second angular velocity \vec{ΩY} may be an angular velocity with respect to a y-axis. The third angular velocity \vec{ΩZ} may be an angular velocity with respect to a z-axis.

The processor 210 may obtain the first rotation data based on the first angular velocity \vec{Ω_{X}}. The first rotation data may include the rotation value for the roll of the electronic device 101 (or the vehicle 110). The rotation value for the roll of the electronic device 101 may be obtained based on the following equation.

$${ϕ}_{GYR} = \sum ( \vec{{Ω}_{X}} \cdot Δ t ) \qquad [ Equation 1 ]$$

Referring to the equation 1, the ϕ_{GYR} means the rotation value for the roll of the electronic device 101. The \vec{Ω_{X}} means the angular velocity with respect to the x-axis. The x-axis may correspond to a direction (or a direction facing the front direction of the vehicle 110) in which the camera 220 faces. The t means a time.

The rotation value for the roll of the electronic device 101 obtained using the gyro sensor 231 may be accurate within a short time. As in the equation 1, since the rotation value for the roll of the electronic device 101 is calculated based on integration, a drift phenomenon may occur by accumulating an error as a time elapses. Therefore, as the time elapses, accuracy of the rotation value for the roll of the electronic device 101 obtained using the gyro sensor 231 may decrease.

According to an embodiment, the processor 210 may obtain the second rotation data by using the acceleration sensor 232. Based on the three axes illustrated in FIG. 1, the processor 210 may obtain first acceleration A_{X}, second acceleration A_{Y}, and third acceleration A_{Z} by using the acceleration sensor 232. The first acceleration A_{X} may be acceleration with respect to the x-axis. The second acceleration A_{Y} may be acceleration with respect to the y-axis. The third acceleration A_{Z} may be acceleration with respect to the z-axis.

The processor 210 may obtain the second rotation data based on the first acceleration A_{X}, the second acceleration A_{Y}, and the third acceleration A_{Z}. The second rotation data may include the rotation value for the roll of the electronic device 101 (or the vehicle 110). The rotation value for the roll of the electronic device 101 may be obtained based on the following equation.

$${ϕ}_{ACC} = atan ( \frac{{A}_{y}}{\sqrt{{A}_{X}^{2} + {A}_{Z}^{2}}} ) \qquad [ Equation 2 ]$$

Referring to the equation 2, the ϕ_{ACC} refers to the rotation value for the roll of the electronic device 101. The A_{X} means acceleration with respect to the x-axis. The A_{Y} means acceleration with respect to the y-axis. The A_{Z} means acceleration with respect to the z-axis. The x-axis may correspond to the direction (or the direction facing the front direction of the vehicle 110) in which the camera 220 faces. The y-axis may correspond to a direction parallel to the ground and perpendicular to the x-axis. The z-axis may correspond to a direction perpendicular to the ground and perpendicular to the x-axis.

The rotation value for the roll of the electronic device 101 obtained using the acceleration sensor 232 may be accurate within a long time. Due to noise of the acceleration sensor 232 within the short time, the rotation value for the roll of the electronic device 101 obtained using the acceleration sensor 232 may not be accurate. Therefore, as a measurement time is shorter, accuracy of the rotation value for the roll of the electronic device 101 obtained using the acceleration sensor 232 may decrease.

In an operation 330, the processor 210 may obtain a rotation value for the video information. For example, the processor 210 may obtain the rotation value for the video information based on the first rotation data and the second rotation data.

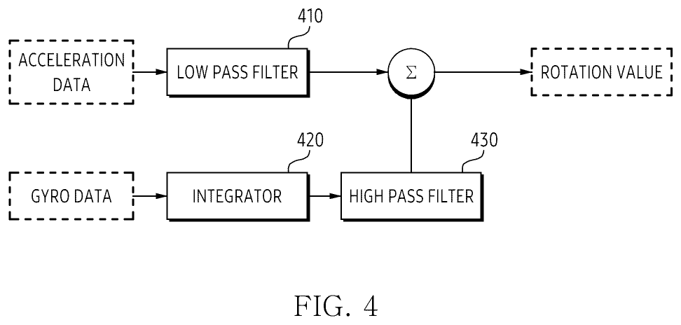

For example, the first rotation data may have high accuracy within the short time. The second rotation data may have high accuracy within the long time. Therefore, the processor 210 may obtain the rotation value for the video information using a complementary filter (or a Kalman filter). A detailed operation of obtaining the rotation value for the video information using the complementary filter will be described later with reference to FIG. 4.

In an operation 340, the processor 210 may identify at least one object regarding the video information. For example, the processor 210 may identify the at least one object regarding the video information based on the obtained rotation value.

For example, the processor 210 may rotate a first video according to the video information based on the obtained rotation value. The processor 210 may obtain a second video by rotating the first video based on the obtained rotation value. The processor 210 may identify at least one bounding box with respect to at least one object included in the second video. The processor 210 may display at least one bounding box, superimposed on the second video. The processor 210 may obtain a third video by rotating (or reversely rotating) the second video based on the obtained rotation value. The third video may be a video in which at least one bounding box is displayed, superimposed on at least one object in the first video.

FIG. 4 illustrates an example of an operation of an electronic device according to an embodiment.

Referring to FIG. 4, a processor 210 of an electronic device 101 may obtain gyro data (e.g., a first angular velocity \vec{Ω_{X}}) by using a gyro sensor 231. The processor 210 may obtain acceleration data (e.g., first acceleration A_{X}, second acceleration A_{Y}, and third acceleration A_{Z}) by using an acceleration sensor 232. The processor 210 may obtain a rotation value with respect to video information by using a complementary filter based on the gyro data and the acceleration data.

For example, the processor 210 may obtain first rotation data based on the gyro data, by using an integrator 420. For example, the processor 210 may obtain the first rotation data based on the gyro data, according to the equation 1. The processor 210 may obtain second rotation data based on the acceleration data. For example, the processor 210 may obtain the second rotation data based on the acceleration data, according to the equation 2.

The acceleration sensor 232 may generate a lot of noise within a high frequency region (or a short time). Therefore, the processor 210 may apply a low pass filter 410 to the second rotation data in order to remove the noise. The gyro sensor 231 may generate a drift phenomenon within a low frequency region (or a long time). Therefore, the processor 210 may apply a high pass filter 430 to the first rotation data in order to remove the drift phenomenon.

The processor 210 may obtain the rotation value with respect to the video information by combining the first rotation data to which the high pass filter 430 is applied and the second rotation data to which the low pass filter 410 is applied. For example, the processor 210 may obtain the rotation value with respect to the video information based on an equation 3.

$${ϕ}_{t} = α \cdot ( {ϕ}_{t - 1} + \vec{{Ω}_{X}} \cdot Δ t ) + ( 1 - α ) \cdot {ϕ}_{ACC} , 0 < α < 1 \qquad [ Equation 3 ]$$

Referring to the equation 3, the α is a constant. The ϕₜ means the rotation value with respect to the video information. The ϕₜ₋₁ means a previously obtained rotation value. The \vec{Ω_{X}} means an angular velocity with respect to an x-axis. The ϕ_{ACC} means a rotation value according to the second rotation data.

Based on applying the high pass filter 430 to the first rotation data, the α·(ϕₜ₋₁+\vec{Ω_{X}}·Δt) may be obtained. Based on applying the low pass filter 410 to the second rotation data, the α·(ϕₜ₋₁)+(1−α)·ϕ_{ACC} may be obtained.

As a size of the α increases, an influence of the first rotation data may increase, and as a size of the α decreases, an influence of the second rotation data may increase. For example, as the size of the α increases, the rotation value with respect to the video information may be obtained close to a rotation value obtained using the gyro sensor 231, and as the size of the α decreases, the rotation value with respect to the video information may be obtained close to a rotation value obtained using the acceleration sensor 232.

FIG. 5A illustrates an example of a value obtained through an acceleration sensor according to an embodiment.

FIG. 5B illustrates an example of an operation of an electronic device according to an embodiment.

Referring to FIG. 5A, an electronic device 101 may identify acceleration of the electronic device 101 by using an acceleration sensor 232. Hereinafter, for convenience of description, an operation in which acceleration is identified in a state that the electronic device 101 is included in a vehicle 110 will be described. For example, the acceleration of the electronic device 101 may correspond to acceleration of the vehicle 110.

According to an embodiment, rotation with respect to a roll may occur while the vehicle 110 is being moved. When the rotation with respect to the roll occurs, gravity 501 and a centrifugal force 502 may occur.

The processor 210 may identify acceleration according to a net force 503 of the gravity 501 and the centrifugal force 502. Although not illustrated, various forces as well as the gravity 501 and the centrifugal force 502 may be applied to the vehicle 110 (or the electronic device 101). Accordingly, it may be difficult for the processor 210 to accurately identify the acceleration of the electronic device 101 using the acceleration sensor 232.

Referring to FIG. 5B, a rotation value with respect the roll identified according to the equation 2 may be accurately identified in a state in which the electronic device 101 is not moved. However, when the acceleration of the electronic device 101 is identified while the electronic device 101 is moving, since acceleration due to gravity and acceleration due to movement are combined, the rotation value with respect to the roll identified according to the Equation 2 may not be accurate.

An image 590 may indicate a frame of a video according to video information obtained through a camera 220 of the electronic device 101. The video information may be obtained while the electronic device 101 rotates and moves rapidly.

In order to identify a rotation value for the video information, the processor 210 may identify first rotation data using a gyro sensor 231 and identify second rotation data using the acceleration sensor 232. The processor 210 may identify the rotation value for the video information based on the first rotation data and the second rotation data.

The processor 210 may identify the first rotation data using the gyro sensor 231. The processor 210 may identify an object 530 indicating a horizontal line in the image 590 based on the first rotation data.

The processor 210 may identify the second rotation data using the acceleration sensor 232. The processor 210 may identify an object 510 indicating the horizontal line in the image 590 based on the second rotation data.

The processor 210 may identify the rotation value with respect to the video information based on the first rotation data and the second rotation data. The processor 210 may identify an object 520 indicating the horizontal line in the image 590 based on the rotation value with respect to the video information.

The object 530 may indicate the horizontal line identified by using the gyro sensor 231. Since the gyro sensor 231 may identify an accurate rotation value for a short time, the object 530 may be closest to a real horizontal line.

The object 510 may indicate the horizontal line identified by using the acceleration sensor 232. As described in FIG. 5A, while the electronic device 101 (or the vehicle 110) is moving, the processor 210 may not be able to identify the accurate rotation value by a force applied to the electronic device 101 (or the vehicle 110). Therefore, the object 510 may not properly indicate the real horizontal line.

The object 520 may indicate the horizontal line based on the horizontal line identified using the acceleration sensor 232 and the horizontal line identified using the gyro sensor 231. Since an error between the horizontal line identified using the acceleration sensor 232 and the real horizontal line is large, the object 520 may also not properly indicate the real horizontal line.

According to an embodiment, the processor 210 may identify a value with respect to the roll of the electronic device 101 (or the vehicle 110) as in the following equation.

$$θ = arctan ( \frac{{v}^{2}}{gr} ) \qquad [ Equation 4 ]$$

Referring to the equation 4, the θ(theta) may indicate the value with respect to the roll of the electronic device 101 (or the vehicle 110). The v may indicate a forward speed of the electronic device 101 (or the vehicle 110). The r may indicate a rotation radius. The g may indicate gravitational acceleration.

In order to identify the value with respect to the roll of the electronic device 101 (or the vehicle 110) using the equation 4, a rotation radius of the electronic device 101 (or the vehicle 110) is required. An additional component for identifying the rotation radius of the electronic device 101 (or the vehicle 110) should be included in the electronic device 101. Therefore, in a state in which the additional component is not included in the electronic device 101, the processor 210 may not identify the value with respect to the roll of the electronic device 101 (or the vehicle 110) by using the equation 4. In addition, since the equation 4 may be used in an ideal state such as a flat road other than an inclined road, a large error may occur in the value with respect to the roll of the electronic device 101 (or the vehicle 110).

As described above, it may be difficult for the processor 210 to identify the accurate rotation value of the video information by using only the gyro sensor 231 and the acceleration sensor 232. Therefore, the processor 210 may identify the rotation value of the video information by using the gyro sensor 231 and a designated estimation model. Hereinafter, a technical feature for identifying the rotation value of the video information using the gyro sensor 231 and the designated estimation model will be described.

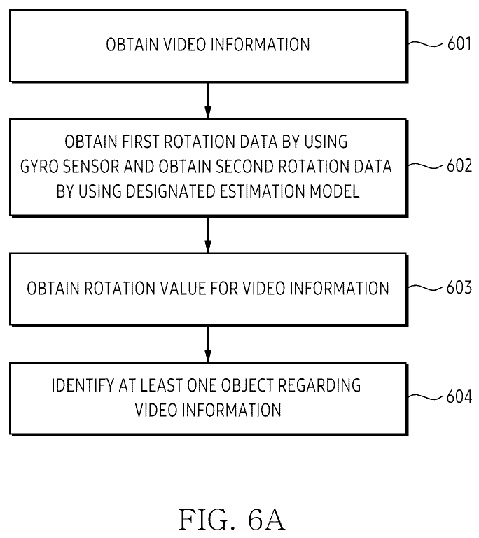

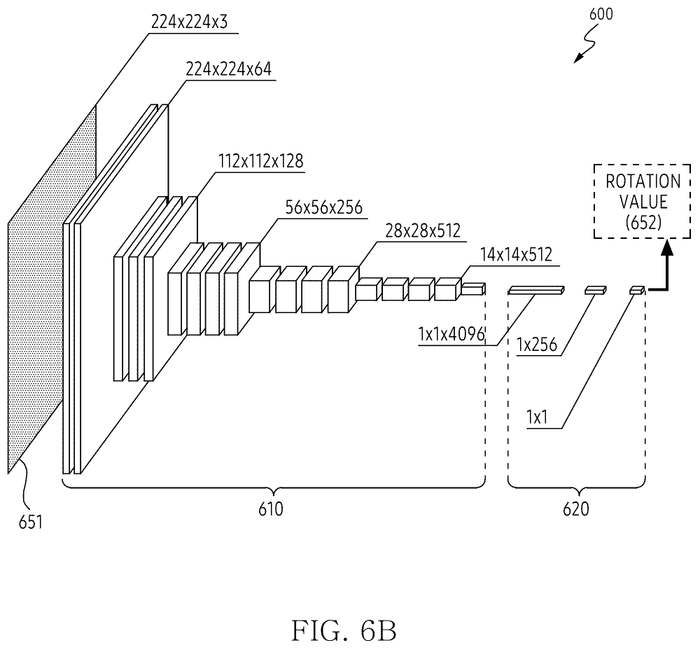

FIG. 6A is an exemplary flowchart for explaining an operation of an electronic device according to an embodiment. The electronic device 101 and/or the processor 210 of FIG. 2 may perform at least one of operations of FIG. 6A. In an embodiment, a computer readable storage medium may be provided, including a software application and/or instructions that cause electronic device 101 and/or the processor 210 to perform the operations of FIG. 6A.

Referring to FIG. 6A, in an operation 601, the processor 210 may obtain video information. For example, the electronic device 101 may be moved together with a vehicle 110. While the electronic device 101 moves together with the vehicle 110, the video information may be obtained by using a camera 220 facing a front direction of the vehicle 110. A first video according to the video information may be in a rotated state based on a rotation value (e.g., a rotation value with respect to a roll) of the vehicle 110.

In an operation 602, the processor 210 may obtain first rotation data by using a gyro sensor 231 and obtain second rotation data by using a designated estimation model.

According to an embodiment, the processor 210 may obtain the first rotation data by using the gyro sensor 231. An operation of obtaining the first rotation data using the gyro sensor 231 may correspond to the operation of obtaining the first rotation data in the operation 320.

According to an embodiment, the processor 210 may obtain the second rotation data by using the designated estimation model. For example, the processor 210 may use the designated estimation model in order to obtain the second rotation data in various driving environments including not only a flat road but also an inclined road.

For example, the designated estimation model may be configured with a combination of a convolution layer and a fully connected (FC) layer. A specific example of the designated estimation model will be described later in FIG. 6B.

For example, the processor 210 may set the video information as input data of the designated estimation model. The processor 210 may obtain the second rotation data based on output data of the designated estimation model. The second rotation data may include the rotation value with respect to the roll of the electronic device 101 (or the vehicle 110). The processor 210 may identify a horizontal line in the video information. The processor 210 may identify the rotation value with respect to the roll of the electronic device 101 (or the vehicle 110) based on identifying an angle at which the horizontal line is rotated in the video information.

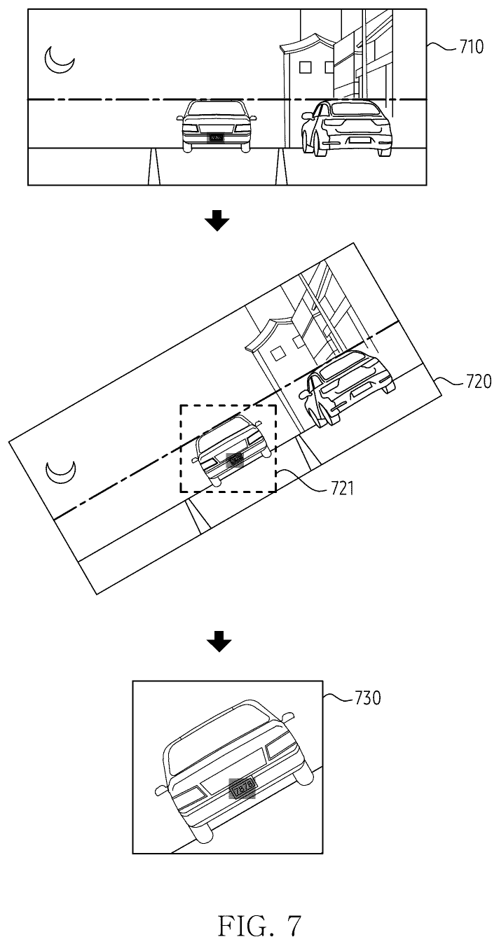

According to an embodiment, the processor 210 may train the designated estimation model based on a first training video and a second training video rotated according to the designated rotation value. A specific example of an operation of training the designated estimation model will be described later with reference to FIG. 7.

In an operation 603, the processor 210 may obtain the rotation value for the video information. For example, the processor 210 may obtain the rotation value for the video information based on the first rotation data and the second rotation data.

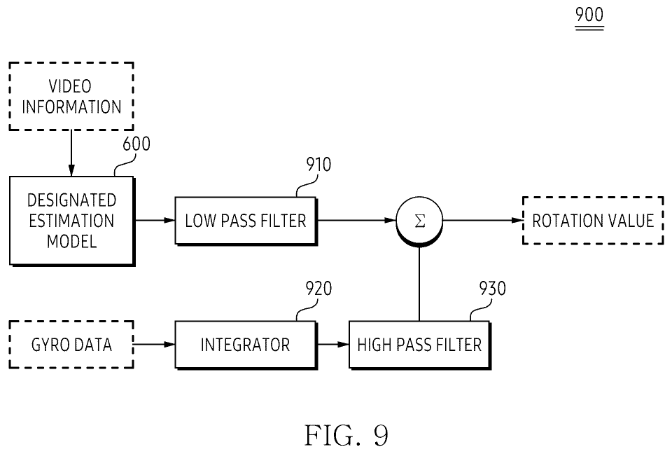

According to an embodiment, since the second rotation data is obtained using the designated estimation model, the rotation value with respect to the roll of the electronic device 101 (or the vehicle 110) may not be properly estimated by a scene (or a frame, a special pattern) that is not used for training. Therefore, the processor 210 may obtain the rotation value for the video information using a complementary filter (or a Kalman filter). A detailed operation of obtaining the rotation value for the video information using the complementary filter will be described later with reference to FIG. 9.

In an operation 604, the processor 210 may identify at least one object regarding the video information. For example, the processor 210 may identify at least one object regarding the video information based on the obtained rotation value.

For example, the processor 210 may rotate the first video according to the video information based on the obtained rotation value. The processor 210 may obtain a second video by rotating the first video based on the obtained rotation value. The processor 210 may identify at least one bounding box with respect to at least one object included in the second video. The processor 210 may display at least one bounding box, superimposed on the second video. The processor 210 may obtain a third video by rotating (or reversely rotating) the second video based on the obtained rotation value. The third video may be a video in which at least one bounding box is displayed and superimposed on at least one object in the first video.

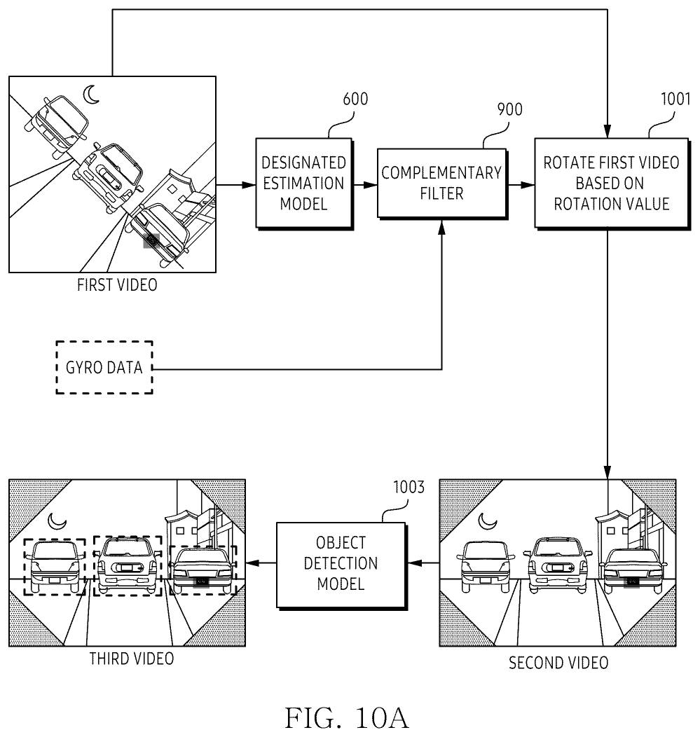

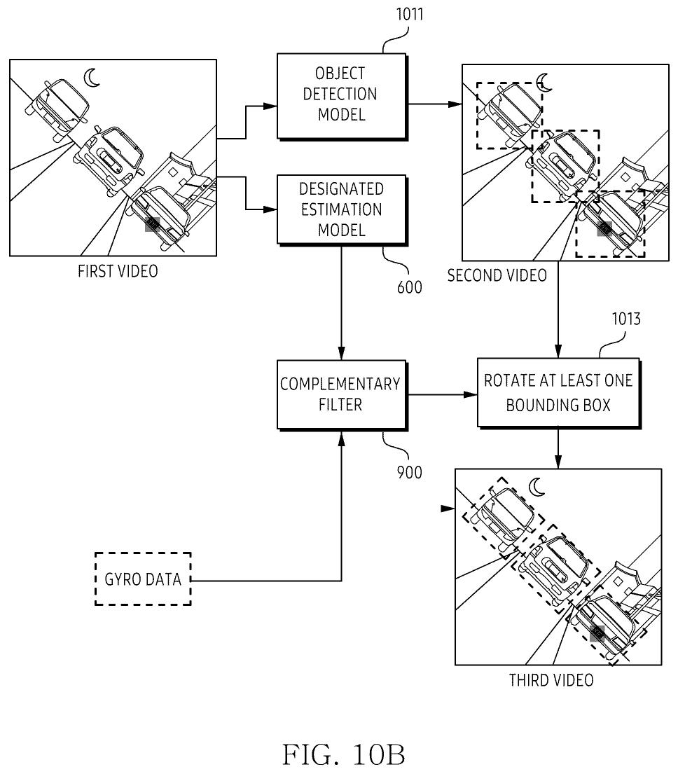

An operation of the electronic device 101 (or the processor 210) for identifying at least one object regarding the video information will be described later in FIGS. 10A and 10B.

FIG. 6B illustrates an example of a designated estimation model according to an embodiment.

Referring to FIG. 6B, a designated estimation model 600 may include a combination of convolutional layers 610 and FC layers 620. For example, the convolutional layers 610 may be used to maintain spatial information with respect to an image 651 and extract a feature. The FC layers 620 may be used to output data within a designated range.

For example, the number of layers of the convolution layers 610 may be 13. For example, the number of layers of the FC layers 620 may be 3. For example, the designated estimation model 600 may be configured based on a VGG16 model. The designated estimation model 600 may include at least a portion of the VGG16 model. For example, the designated estimation model 600 may be a model in which an FC layer for regression is added to a final classification end in the VGG16 model.

The image 651 may be set as input data on the convolutional layers 610. For example, the image 651 may be a frame of a video based on video information obtained by using a camera 220. The image 651 may be configured with a three dimensional vector of 222×224×3. Based on output data on the convolutional layers 610, a three dimensional vector of 7×7×512 may be identified. The three dimensional vector of 7×7×512 may be set as input data of the FC layers 620. A rotation value 652 may be outputted within a designated range (e.g., greater than or equal to 0 and less than or equal to 25 degrees) through the FC layers 620.

Therefore, the processor 210 may train the designated estimation model 600 by using a driving video (or a driving image) with respect to various environments. The processor 210 may obtain second rotation data by using the designated estimation model 600. The second rotation data may include the rotation value with respect to the roll of the electronic device 101 (or the vehicle 110).

FIG. 7 illustrates an example of training data of a designated estimation model according to an embodiment.

Referring to FIG. 7, a processor 210 may train the designated estimation model. For example, a video and a rotation value obtained while an electronic device 101 (or a vehicle 110) is moving may be required for learning the designated estimation model. A large resource may be required to obtain the video and the rotation value obtained while the electronic device 101 (or the vehicle 110) is moving. Therefore, the processor 210 may identify an image 710, an image 720, and an image 730 for augmentation of the training data.

The Image 710 is rotated by 0°. The processor 210 may obtain the image 710 in a state in which a rotation value for a roll is 0° while the vehicle 110 is driving. The processor 210 may identify the image 710 as a ground truth. The processor 210 may train a designated estimation model 600 based on the image 710.

The processor 210 may obtain the image 720 by rotating the image 710 according to a designated rotation value. The processor 210 may crop a region 721 including an object in the image 720. The processor 210 may obtain (or identify) the image 730 by cropping the region 721 including the object in the image 720. The processor 210 may identify the image 730 as the ground truth with respect to the designated rotation value. For example, the processor 210 may remove an outer region of an image by cropping the region 721 including the object in the image 720. According to an embodiment, the processor 210 may obtain the image 730 by cropping a designated area (e.g., a central area) in the image 720 regardless of the object.

For example, the processor 210 may set the designated rotation value to an arbitrary value within a designated range. The processor 210 may obtain a ground truth image (e.g., the image 730) by obtaining an image rotated according to various rotation values.

Therefore, the processor 210 may obtain the image 730 based on rotating the obtained image 710 while the rotation value of the electronic device 101 is 0° based on the designated rotation value. The processor 210 may identify the image 730 as the ground truth with respect to the designated rotation value.

In the above-described embodiment, an example of learning the designated estimation model 600 using images (e.g., the image 710, the image 720, and the image 730) for convenience of description is illustrated, but is not limited thereto. The processor 210 may identify a first learning video as the ground truth. The processor 210 may obtain a second learning video based on rotating the first learning video according to the designated rotation value. The processor 210 may identify the second learning video as the ground truth with respect to the designated rotation value.

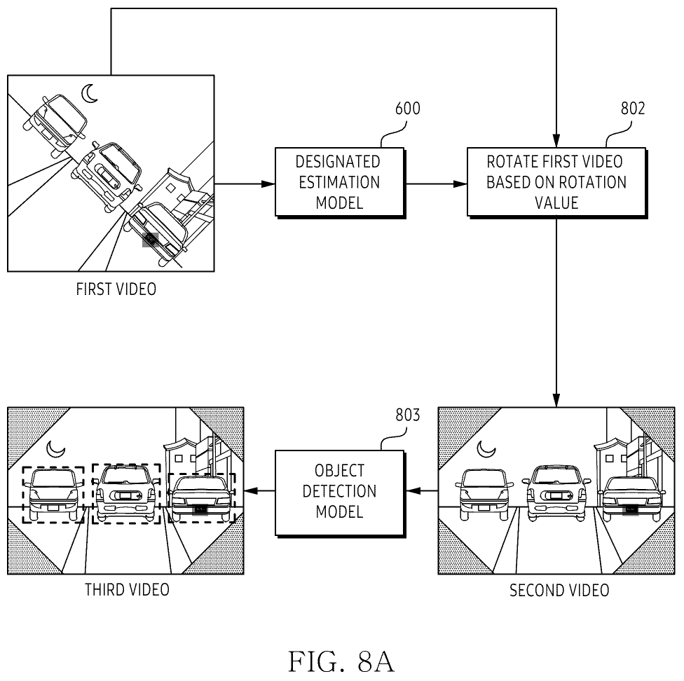

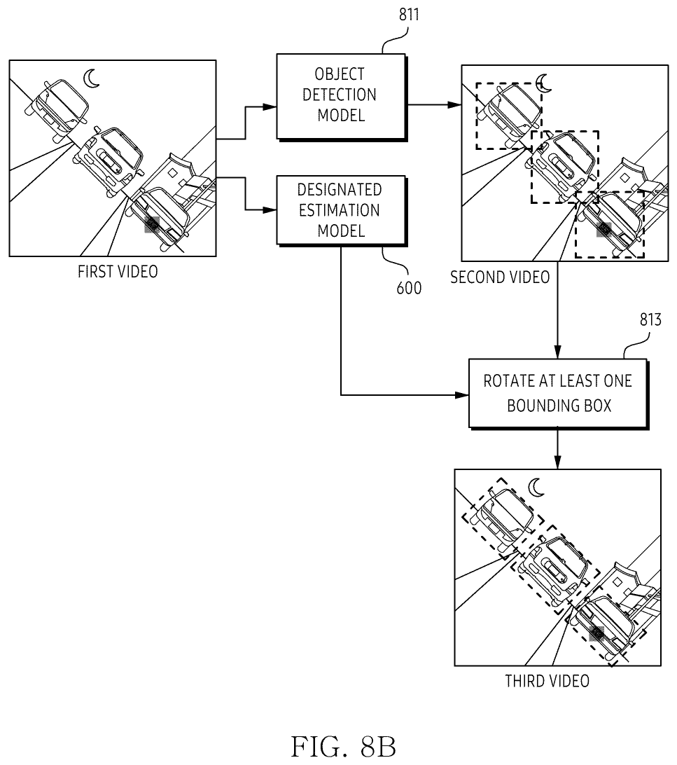

FIG. 8A illustrates an example of an operation of an electronic device according to an embodiment.

FIG. 8B illustrates an example of an operation of an electronic device according to an embodiment.

Referring to FIG. 8A, a processor 210 may obtain video information by using a camera 220. The processor 210 may identify a first video according to the video information.

The processor 210 may obtain (or identify) a rotation value by using a designated estimation model 600. The processor 210 may set the video information (or the first video) as input data of the designated estimation model 600. The processor 210 may obtain (or identify) the rotation value based on output data of the designated estimation model 600.

In an operation 802, the processor 210 may rotate the first video based on the obtained rotation value. The processor 210 may obtain (or identify) a second video based on rotating the first video. The second video may be a video from which rotation is removed from the first video. The processor 210 may set the second video as input data of an object detection model 803. The processor 210 may obtain a third video based on output data of the object detection model 803. The processor 210 may identify at least one object in the second video through the object detection model 803. The processor 210 may obtain the third video in which at least one bounding box regarding at least one object is displayed and superimposed on the second video.

Referring to FIG. 8B, the processor 210 may obtain the video information by using the camera 220. The processor 210 may identify the first video according to the video information.

The processor 210 may set the video information (or the first video) as input data of an object detection model 811. The processor 210 may obtain the second video based on output data of the object detection model 811. The processor 210 may identify at least one object in the first video through the object detection model 811. The processor 210 may obtain the second video in which at least one bounding box regarding at least one object is displayed and superimposed on the first video.

The processor 210 may obtain (or identify) the rotation value by using the designated estimation model 600. The processor 210 may set the video information (or the first video) as the input data of the designated estimation model 600. The processor 210 may obtain (or identify) the rotation value based on the output data of the designated estimation model 600.

In an operation 813, the processor 210 may rotate the at least one bounding box based on the obtained rotation value. For example, since the at least one object in the second video is in a rotated state, the at least one bounding box may be configured to be larger than the at least one object. The processor 210 may obtain the third video in which the at least one bounding box is corrected and displayed by rotating the at least one bounding box.

Referring again to FIG. 8A, the processor 210 may identify the at least one object using the object detection model 803 after rotating the first video. Since a non-rotated video (or image) is set as the input data of the object detection model 803, the general object detection model 803 may be used. However, latency may occur due to the rotation of the first video.

Referring again to FIG. 8B, the processor 210 may identify the at least one object using the object identification model 811 without rotating the first video. The processor 210 may rotate the at least one bounding box identified based on the object identification model 811. Since the first video is not rotated, the at least one object may be identified with low latency. However, the processor 210 may need to configure the rotated video as training data of the object identification model 811.

FIG. 9 illustrates an example of an operation of an electronic device according to an embodiment.

Referring to FIG. 9, a processor 210 of an electronic device 101 may obtain gyro data (e.g., a first angular velocity \vec{Ω_{X}}) by using a gyro sensor 231. The processor 210 may obtain video information by using a camera 220. The processor 210 may obtain a rotation value with respect to the video information by using a complementary filter 900 based on the gyro data and the video information.

For example, the processor 210 may obtain first rotation data, by using an integrator 920 based on the gyro data. For example, the processor 210 may obtain the first rotation data based on the gyro data, according to the equation 1. The processor 210 may obtain second rotation data by using a designated estimation model 600 based on the video information. For example, the processor 210 may set the video information as input data of the designated estimation model 600. The processor 210 may obtain the second rotation data based on output data of the designated estimation model 600.

Since the second rotation data is obtained using the designated estimation model 600, a rotation value with respect to a roll of the electronic device 101 (or a vehicle 110) may not be properly estimated by a scene (or a frame, a special pattern) that is not used for training. Therefore, the processor 210 may obtain the rotation value for the video information by using a complementary filter (or a Kalman filter) based on the first rotation data and the second rotation data. For example, the processor 210 may obtain the rotation value with respect to the video information based on an equation 5.

$${ϕ}_{t} = α \cdot ( {ϕ}_{t - 1} + \vec{{Ω}_{X}} \times Δ t ) + ( 1 - α ) \cdot {ϕ}_{IMG} , 0 < α < 1 \qquad [ Equation 5 ]$$

Referring to the equation 5, the α is a constant. The ϕₜ means the rotation value with respect to the video information. The ϕₜ₋₁ means a previously obtained rotation value. The \vec{Ω_{X}} means an angular velocity with respect to an x-axis. The ϕ_{IMG} means a rotation value according to the second rotation data.

Based on applying a high pass filter 930 to the first rotation data, the α·(ϕₜ₋₁+\vec{Ω_{X}}·Δt) may be obtained. Based on applying a low pass filter 910 to the second rotation data, the α·(ϕₜ₋₁)+(1−α)·ϕ_{IMG} may be obtained.

For example, within a short time, the rotation value with respect to the video information may be close to a rotation value included in the first rotation data obtained using the gyro sensor 231. For example, within a long time, the rotation value with respect to the video information may be close to a rotation value included in the second rotation data obtained using the designated estimation model 600.

FIG. 10A illustrates an example of an operation of an electronic device according to an embodiment.

FIG. 10B illustrates an example of an operation of an electronic device according to an embodiment.

Referring to FIG. 10A, a processor 210 may obtain video information by using a camera 220. The processor 210 may identify a first video according to the video information.

The processor 210 may identify at least one object by using a designated estimation model 600. The processor 210 may set the first video (or the video information) as input data of the designated estimation model 600. The processor 210 may obtain second rotation data based on output data of the designated estimation model 600. The processor 210 may obtain first rotation data by using gyro data. The processor 210 may set the first rotation data and the second rotation data as an input value of a complementary filter 900. The processor 210 may obtain a rotation value with respect to the video information by using the complementary filter 900 described in FIG. 9. For example, the processor 210 may obtain the rotation value with respect to the video information by using the equation 5.

In an operation 1001, the processor 210 may rotate the first video based on the obtained rotation value. The processor 210 may obtain (or identify) the second video based on rotating the first video. The second video may be a video from which rotation is removed from the first video. The processor 210 may set the second video as input data of an object detection model 1003. The processor 210 may obtain a third video based on output data of the object detection model 1003. The processor 210 may identify at least one object in the second video through the object detection model 1003. The processor 210 may obtain the third video in which at least one bounding box regarding at least one object is displayed and superimposed on the second video.

Referring to FIG. 10B, the processor 210 may obtain the video information by using the camera 220. The processor 210 may identify the first video according to the video information.

The processor 210 may set the video information (or the first video) as input data of an object detection model 1011. The processor 210 may obtain the second video based on output data of the object detection model 1011. The processor 210 may identify at least one object in the first video through the object detection model 1011. The processor 210 may obtain the second video in which at least one bounding box regarding at least one object is displayed and superimposed on the first video.

The processor 210 may obtain (or identify) the second rotation data by using the designated estimation model 600. The processor 210 may set the video information (or the first video) as input data of the designated estimation model 600. The processor 210 may obtain (or identify) the rotation value based on output data of the designated estimation model 600. The processor 210 may obtain the first rotation data by using the gyro data. The processor 210 may set the first rotation data and the second rotation data as the input value of the complementary filter 900. The processor 210 may obtain the rotation value with respect to the video information by using the complementary filter 900 described in FIG. 9. For example, the processor 210 may obtain the rotation value with respect to the video information by using the equation 5.

In an operation 1013, the processor 210 may rotate at least one bounding box based on the obtained rotation value. For example, since the at least one object in the second video is in a rotated state, the at least one bounding box may be configured to be larger than the at least one object. The processor 210 may obtain the third video in which the at least one bounding box is corrected and displayed by rotating the at least one bounding box.

Referring again to FIG. 10A, the processor 210 may identify the at least one object using the object identification model 1003 after rotating the first video. Since a non-rotated video (or image) is set as the input data of the object identification model 1003, the general object identification model 1003 may be used. However, latency may occur due to the rotation of the first video.

Referring again to FIG. 10B, the processor 210 may identify the at least one object using the object identification model 1011 without rotating the first video. The processor 210 may rotate the at least one bounding box identified based on the object identification model 1011. Since the first video is not rotated, the at least one object may be identified with low latency. However, the processor 210 may need to configure the rotated video as training data of the object identification model 1011.

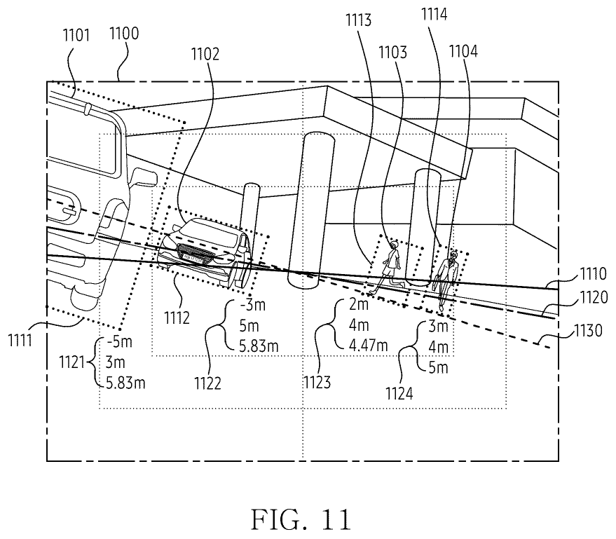

FIG. 11 illustrates an example of an operation of an electronic device according to an embodiment.

Referring to FIG. 11, a processor 210 may obtain the video information by using a camera 220. An image 1100 may be obtained based on a frame of the first video according to the video information. The processor 210 may display the image 1100 by using a display included in the electronic device 101 or a display of an external device.

The processor 210 may obtain first rotation data by using a gyro sensor 231. An object 1110 may be displayed based on a rotation value identified through the first rotation data. The object 1110 may indicate a horizontal line identified based on the first rotation data in the image 1100.

The processor 210 may obtain second rotation data by using a designated estimation model 600. An object 1120 may be displayed based on a rotation value identified through the second rotation data. The object 1120 may indicate the horizontal line identified based on the second rotation data in the image 1100.

The processor 210 may identify a rotation value for the video information based on the first rotation data and the second rotation data. The processor 210 may display an object 1130 in the image 1100, based on the rotation value for the video information. For example, the processor 210 may obtain the rotation value for the video information by using a complementary filter 900 based on the first rotation data and the second rotation data. The object 1130 may be displayed based on the rotation value for the video information. The object 1130 may indicate the horizontal line identified based on the rotation value for the video information.

The processor 210 may obtain the rotation value for the video information based on the first rotation data and the second rotation data. The processor 210 may display the object 1130 indicating the horizontal line close to a real horizontal line in the image 1110 based on the rotation value for the video information.

According to an embodiment, the processor 210 may identify at least one object in the image 1100 based on the rotation value for the video information. The processor 210 may rotate the image 1100 based on the rotation value. After the image 1100 is rotated, the processor 210 may identify the at least one object using an object detection model.

The processor 210 may display at least one bounding box regarding the identified at least one object in the image 1100. The at least one bounding box may be rotated based on the rotation value for the video information. For example, the processor 210 may identify an object 1101, an object 1102, an object 1103, and an object 1104 in the image 1100. The processor 210 may display a bounding box 1111 according to a shape of the object 1101 in the image 1100. The processor 210 may display a bounding box 1112 according to a shape of the object 1102 in the image 1100. The processor 210 may display a bounding box 1113 according to a shape of the object 1103 in the image 1100. The processor 210 may display a bounding box 1114 according to a shape of the object 1104 in the image 1100.

For example, the bounding box 1111, the bounding box 1112, the bounding box 1113, and the bounding box 1114 may be a rotated state based on the rotation value for the video information.

According to an embodiment, the processor 210 may display a text 1121 indicating information on the object 1101 in the image 1100 together with the bounding box 1111. The information on the object 1101 may indicate a distance between the electronic device 101 and a real object corresponding to the object 1101. For example, the text 1121 may indicate a distance (i.e., −5 m) in a first direction (e.g., a left direction or a right direction), a distance (i.e., 3 m) in a second direction (e.g., a forward direction), and the shortest distance (i.e., 5.83 m).

The processor 210 may display a text 1122 indicating information on the object 1102 in the image 1100 together with the bounding box 1112. The information on the object 1102 may indicate a distance between the electronic device 101 and a real object corresponding to the object 1102. For example, the text 1121 may represent a distance (i.e., −3 m) in the first direction (e.g., the left direction or the right direction), a distance (i.e., 5 m) in the second direction (e.g., the forward direction), and the shortest distance (i.e., 5.83 m).

The processor 210 may display a text 1123 indicating information on the object 1103 in the image 1100 together with the bounding box 1113. The information on the object 1103 may indicate a distance between the electronic device 101 and a real object corresponding to the object 1103. For example, the text 1123 may indicate a distance (i.e., 2 m) in the first direction (e.g., the left direction or the right direction), a distance (i.e., 4 m) in the second direction (e.g., the forward direction), and the shortest distance (i.e., 4.47 m).

The processor 210 may display a text 1124 indicating information on the object 1104 in the image 1100 together with the bounding box 1114. The information on the object 1104 may indicate a distance between the electronic device 101 and a real object corresponding to the object 1104. For example, the text 1124 may indicate a distance (i.e., 3 m) in the first direction (e.g., the left direction or the right direction), a distance (i.e., 4 m) in the second direction (e.g., the forward direction), and the shortest distance (i.e., 5 m).

As described above, the processor 210 may configure a bounding box according to a size of an object and display the bounding box in an image (or a video). The processor 210 may rotate and display the bounding box according to a rotation value of the video.

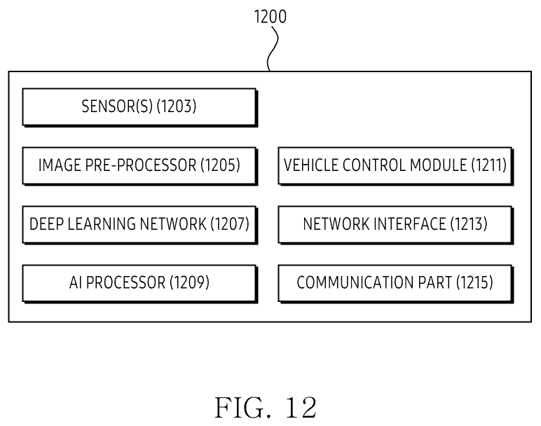

FIG. 12 is an example block diagram illustrating an autonomous driving system of a vehicle according to an embodiment.

The autonomous driving system 1200 of the vehicle according to FIG. 12 may be a deep learning network including sensors 1203, an image preprocessor 1205, a deep learning network 1207, an artificial intelligence (AI) processor 1209, a vehicle control module 1211, a network interface 1213, and a communication unit 1215. In various embodiments, each element may be connected via a variety of interfaces. For example, sensor data detected and output by the sensors 1203 may be fed to the image preprocessor 1205. The sensor data processed by the image preprocessor 1205 may be fed to the deep learning network 1207 run on the AI processor 1209. An output of the deep learning network 1207 run by the AI processor 1209 may be fed to the vehicle control module 1211. Intermediate results of the deep learning network 1207 run on the AI processor 1209 may be fed to the AI processor 1209. In various embodiments, the network interface 1213 communicates with an electronic device in the vehicle to transmit autonomous driving route information and/or autonomous driving control commands for autonomous driving of the vehicle to its internal block components. In an embodiment, the network interface 1213 may be used to transmit sensor data obtained through the sensor(s) 1203 to an external server. In some embodiments, the autonomous driving control system 1200 may include additional or fewer components as appropriate. For example, in some embodiments, the image preprocessor 1205 may be an optional component. As another example, a post-processing element (not shown) may be included in the autonomous driving control system 1200 to perform post-processing of the output of the deep learning network 1207 before the output is provided to the vehicle control module 1211.

In some embodiments, the sensors 1203 may include one or more sensors. In various embodiments, the sensors 1203 may be attached to various different positions of the vehicle. The sensors 1203 may be arranged to face one or more different directions. For example, the sensors 1203 may be attached to the front, sides, rear, and/or roof of the vehicle to face directions such as forward-facing, rear-facing, side-facing and the like. In some embodiments, the sensors 1203 may be image sensors such as e.g., high dynamic range cameras. In some embodiments, the sensors 1203 may include non-visual sensors. In some embodiments, the sensors 1203 may include a radar, a light detection and ranging (LiDAR), and/or ultrasonic sensors in addition to the image sensor. In some embodiments, the sensors 1203 are not mounted on the vehicle having the vehicle control module 1211. For example, the sensors 1203 may be incorporated as a part of a deep learning system for capturing sensor data and may be installed onto an environment or a roadway and/or mounted on surrounding vehicles.

In some embodiments, the image preprocessor 1205 may be used to preprocess sensor data of the sensors 1203. For example, the image preprocessor 1205 may be used to preprocess sensor data to split sensor data into one or more components, and/or to post-process the one or more components. In some embodiments, the image preprocessor 1205 may be any one of a graphics processing unit (GPU), a central processing unit (CPU), an image signal processor, or a specialized image processor. In various embodiments, the image preprocessor 1205 may be a tone-mapper processor for processing high dynamic range data. In some embodiments, the image preprocessor 1205 may be a component of the AI processor 1209.

In some embodiments, the deep learning network 1207 may be a deep learning network for implementing control commands for controlling the autonomous vehicle. For example, the deep learning network 1207 may be an artificial neural network such as a convolution neural network (CNN) trained using sensor data, and the output of the deep learning network 1207 is provided to the vehicle control module 1211.

In some embodiments, the AI processor 1209 may be a hardware processor for running the deep learning network 1207. In some embodiments, the AI processor 1209 may be a specialized AI processor adapted to perform inference on sensor data through a CNN. In some embodiments, the AI processor 1209 may be optimized for a bit depth of the sensor data. In some embodiments, the AI processor 1209 may be optimized for deep learning operations such as operations in neural networks including convolution, inner product, vector, and/or matrix operations. In some embodiments, the AI processor 1209 may be implemented through a plurality of graphics processing units (GPUs) capable of effectively performing parallel processing.

In various embodiments, the AI processor 1209 may be coupled, through an input/output interface, to a memory configured to provide an AI processor having instructions causing the AI processor to perform deep learning analysis on the sensor data received from the sensor(s) 1203 while the AI processor 1209 is executed, and determine a result of machine learning used to operate a vehicle at least partially autonomously. In some embodiments, the vehicle control module 1211 may be used to process commands for vehicle control outputted from the AI processor 1209, and to translate the output of the AI processor 1209 into commands for controlling modules of each vehicle in order to control various modules in the vehicle. In some embodiments, the vehicle control module 1211 is used to control an autonomous driving vehicle. In some embodiments, the vehicle control module 1211 may adjust the steering and/or speed of the vehicle. For example, the vehicle control module 1211 may be used to control driving of a vehicle such as e.g., deceleration, acceleration, steering, lane change, keeping lane or the like. In some embodiments, the vehicle control module 1211 may generate control signals for controlling vehicle lighting, such as e.g., brake lights, turns signals, and headlights. In some embodiments, the vehicle control module 1211 may be used to control vehicle audio-related systems such as e.g., a vehicle's sound system, vehicle's audio warnings, a vehicle's microphone system, and a vehicle's horn system.

In some embodiments, the vehicle control module 1211 may be used to control notification systems including alert systems for notifying passengers and/or a driver of driving events, such as e.g., approaching an intended destination or a potential collision. In some embodiments, the vehicle control module 1211 may be used to adjust sensors such as the sensors 1203 of the vehicle. For example, the vehicle control module 1211 may control to modify the orientation of the sensors 1203, change the output resolution and/or format type of the sensors 1203, increase or decrease a capture rate, adjust a dynamic range, and adjust the focus of the camera. In addition, the vehicle control module 1211 may control to turn on/off the operation of the sensors individually or collectively.

In some embodiments, the vehicle control module 1211 may be used to change the parameters of the image preprocessor 1205 by means of modifying a frequency range of filters, adjusting features and/or edge detection parameters for object detection, adjusting bit depth and channels, or the like. In various embodiments, the vehicle control module 1211 may be used to control autonomous driving of the vehicle and/or driver assistance features of the vehicle.

In some embodiments, the network interface 1213 may serve as an internal interface between the block components of the autonomous driving control system 1200 and the communication unit 1215. Specifically, the network interface 1213 may be a communication interface for receiving and/or transmitting data including voice data. In various embodiments, the network interface 1213 may be connected to external servers via the communication unit 1215 to connect voice calls, receive and/or send text messages, transmit sensor data, update software of the vehicle to the autonomous driving system, or update software of the autonomous driving system of the vehicle.

In various embodiments, the communication unit 1215 may include various wireless interfaces of a cellular or WiFi type. For example, the network interface 1213 may be used to receive updates of the operation parameters and/or instructions for the sensors 1203, the image preprocessor 1205, the deep learning network 1207, the AI processor 1209, and the vehicle control module 1211 from an external server connected via the communication unit 1215. For example, a machine learning model of the deep learning network 1207 may be updated using the communication unit 1215. According to another embodiment, the communication unit 1215 may be used to update the operating parameters of the image preprocessor 1205, such as image processing parameters, and/or the firmware of the sensors 1203.

In another embodiment, the communication unit 1215 may be used to activate communication for emergency services and emergency contacts in an event of a traffic accident or a near-accident. For example, in a vehicle crash event, the communication unit 1215 may be used to call emergency services for help, and may be used to externally notify the crash details and the location of the vehicle to the designated emergency services. In various embodiments, the communication unit 1215 may update or obtain an expected arrival time and/or a location of destination.

According to an embodiment, the autonomous driving system 1200 illustrated in FIG. 12 may be configured as an electronic device of a vehicle. According to an embodiment, when an autonomous driving release event occurs from the user while performing the autonomous driving of the vehicle, the AI processor 1209 of the autonomous driving system 1200 may make a control to input information related to the autonomous driving release event to the training set data of the deep learning network, thereby controlling to train the autonomous driving software of the vehicle.

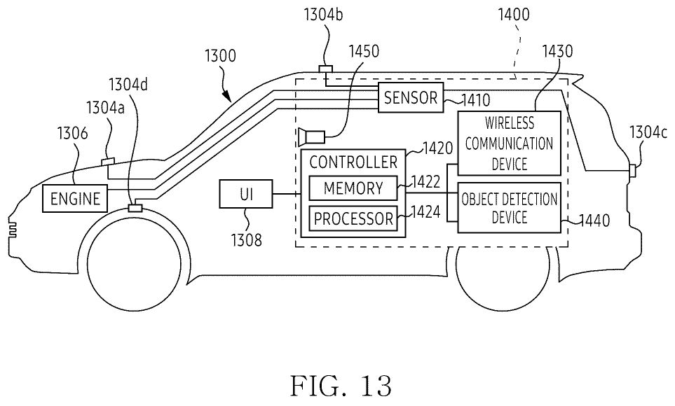

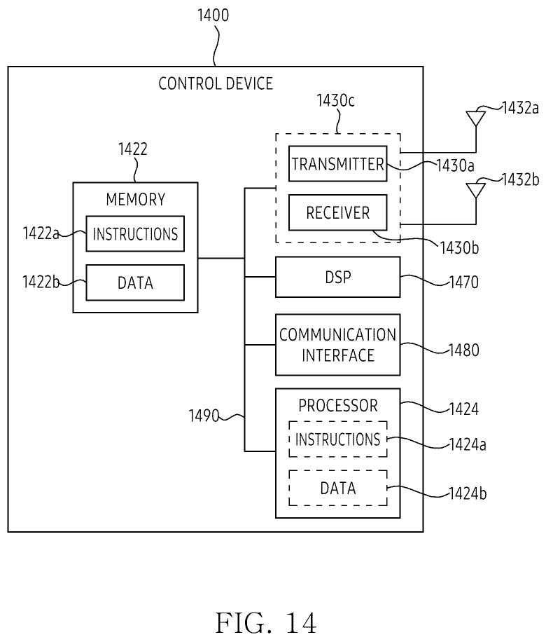

FIGS. 13 and 14 are example block diagrams illustrating an autonomous driving mobile body according to an embodiment. Referring to FIG. 13, the autonomous driving mobile body 1300 according to the present embodiment may include a control device 1400, sensing modules (1304a, 1304b, 1304c, 1304d), an engine 1306, and a user interface 1308.

The autonomous driving mobile body 1300 may have an autonomous driving mode or a manual mode. For example, according to a user input received through the user interface 1308, the manual mode may be switched to the autonomous driving mode, or the autonomous driving mode may be switched to the manual mode.

When the mobile body 1300 is operated in the autonomous driving mode, the autonomous driving mobile body 1300 may be operated under the control of the control device 1400.

In this embodiment, the control device 1400 may include a controller 1420 including a memory 1422 and a processor 1424, a sensor 1410, a communication device 1430, and an object detection device 1440.

Here, the object detection device 1440 may perform all or some of functions of the distance measuring device (e.g., the electronic device 101).

In other words, in the present embodiment, the object detection device 1440 is a device for detecting an object located outside the mobile body 1300, and the object detection device 1440 may be configured to detect an object located outside the mobile body 1300 and generate object information according to a result of the detection.

The object information may include information on the presence or absence of an object, location information of the object, distance information between the mobile body and the object, and relative speed information between the mobile body and the object.

The object may include various objects located outside the mobile body 1300, such as a traffic lane, another vehicle, a pedestrian, a traffic signal, light, a roadway, a structure, a speed bump, terrain, an animal, and the like. Here, the traffic signal may be of a concept including a traffic light, a traffic sign, a pattern or text drawn on a road surface. The light may be light generated from a lamp provided in another vehicle, light emitted from a streetlamp, or sunlight.

Further, the structure may indicate an object located around the roadway and fixed to the ground. For example, the structure may include, for example, a streetlamp, a street tree, a building, a telephone pole, a traffic light, a bridge, and the like. The terrain may include mountains, hills, and the like.

Such an object detection device 1440 may include a camera module. The controller 1420 may extract object information from an external image captured by the camera module and allow the controller 1420 to process the information.

Further, the object detection device 1440 may further include imaging devices for recognizing an external environment. A RADAR, a GPS device, a driving distance measuring device (odometer), other computer vision devices, ultrasonic sensors, and infrared sensors may be used in addition to a LIDAR, and these devices may be operated optionally or simultaneously as needed to enable more precise detection.

Meanwhile, the distance measuring device according to an embodiment of the disclosure may calculate the distance between the autonomous driving mobile body 1300 and the object, and control the operation of the mobile body based on the distance calculated in association with the control device 1400 of the autonomous driving mobile body 1300.

For example, when there is a possibility of collision depending upon the distance between the autonomous driving mobile body 1300 and the object, the autonomous driving mobile body 1300 may control the brake to slow down or stop. As another example, when the object is a moving object, the autonomous driving mobile body 1300 may control the driving speed of the autonomous driving mobile body 1300 to maintain a predetermined distance or more from the object.

The distance measuring device according to an embodiment of the disclosure may be configured as one module within the control device 1400 of the autonomous driving mobile body 1300. In other words, the memory 1422 and the processor 1424 of the control device 1400 may be configured to implement in software a collision avoidance method according to the present disclosure.

Further, the sensor 1410 may be connected to the sensing modules (1304a, 1304b, 1304c, 1304d) to obtain various sensing information about the environment inside and outside the mobile body. Here, the sensor 1410 may include, for example, a posture sensor (e.g., a yaw sensor, a roll sensor, a pitch sensor), a collision sensor, a wheel sensor, a speed sensor, an inclination sensor, a weight detection sensor, a heading sensor, a gyro sensor, a position module, a mobile body forward/backward sensor, a battery sensor, a fuel sensor, a tire sensor, a steering sensor for steering wheel rotation, a mobile body internal temperature sensor, a mobile body internal humidity sensor, an ultrasonic sensor, an illuminance sensor, an accelerator pedal position sensor, a brake pedal position sensor, and the like.

As such, the sensor 1410 may obtain various sensing signals, such as e.g., mobile body posture information, mobile body collision information, mobile body direction information, mobile body position information (GPS information), mobile body angle information, mobile body speed information, mobile body acceleration information, mobile body inclination information, mobile body forward/backward driving information, battery information, fuel information, tire information, mobile body lamp information, mobile body internal temperature information, mobile body internal humidity information, steering wheel rotation angle, mobile body external illuminance, pressure applied to an accelerator pedal, pressure applied to a brake pedal, and so on.

Further, the sensor 1410 may further include an accelerator pedal sensor, a pressure sensor, an engine speed sensor, an air flow sensor (AFS), an intake air temperature sensor (ATS), a water temperature sensor (WTS), a throttle position sensor (TPS), a top dead center (TDC) sensor, a crank angle sensor (CAS), and the like.

As such, the sensor 1410 may generate mobile body state information based on various detected data.

A wireless communication device 1430 may be configured to implement wireless communication between the autonomous driving mobile bodies 1300. For example, the autonomous driving mobile body 1300 can communicate with a mobile phone of the user or another wireless communication device 1430, another mobile body, a central apparatus (traffic control device), a server, or the like. The wireless communication device 1430 may transmit and receive wireless signals according to a wireless access protocol. The wireless communication protocol may be, for example, of Wi-Fi, Bluetooth, Long-Term Evolution (LTE), Code Division Multiple Access (CDMA), Wideband Code Division Multiple Access (WCDMA), and Global Systems for Mobile Communications (GSM), and the communication protocol is not limited thereto.

Further, according to the present embodiment, the autonomous driving mobile body 1300 may implement wireless communication between mobile bodies via the wireless communication device 1430. In other words, the wireless communication device 1430 may communicate with another mobile body and other mobile bodies over the road through vehicle-to-vehicle (V2V) communication. The autonomous driving mobile body 1300 may transmit and receive information, such as driving warnings and traffic information, via the vehicle-to-vehicle communication, and may request information or receive such a request from another vehicle. For example, the wireless communication device 1430 may perform the V2V communication with a dedicated short-range communication (DSRC) apparatus or a cellular-V2V (C-V2V) apparatus. In addition to vehicle-to-vehicle communication, vehicle-to-everything (V2X) communication between a vehicle and another object (e.g., an electronic device carried by a pedestrian) may also be implemented using the wireless communication device 1430.

Further, the wireless communication device 1430 may obtain, as information for autonomous driving of the autonomous driving mobile body 1300, information generated by various mobility devices including infrastructure (traffic lights, CCTVs, RSUs, eNode B, etc.), other autonomous driving/non-autonomous driving vehicles or the like that are located on a roadway over a non-terrestrial network other than a terrestrial network.

For example, the wireless communication device 1430 may perform wireless communication with a low earth orbit (LEO) satellite system, a medium earth orbit (MEO) satellite system, a geostationary orbit (GEO) satellite system, a high altitude platform (HAP) system, and so on, all these systems constituting a non-terrestrial network, via a dedicated non-terrestrial network antenna mounted on the autonomous driving mobile body 1300.

For example, the wireless communication device 1430 may perform wireless communication with various platforms that configure a Non-Terrestrial Network (NTN) according to the wireless access specification complying with the 5G NR NTN (5^{th} Generation New Radio Non-Terrestrial Network) standard currently being discussed in 3GPP and others, but the disclosure is not limited thereto.

In this embodiment, the controller 1420 may control the wireless communication device 1430 to select a platform capable of appropriately performing the NTN communication in consideration of various information, such as the location of the autonomous driving mobile body 1300, the current time, available power, and the like and to perform wireless communication with the selected platform.

In this embodiment, the controller 1420, which is a unit for controlling the overall operation of each unit in the mobile body 1300, may be configured at the time of manufacture by a manufacturer of the mobile body or may be additionally adapted to perform an autonomous driving function after its manufacture. Alternatively, a configuration may be included for enabling the controller to continue ongoing additional functions through upgrades to the controller 1420 configured at the time of its manufacturing. Such a controller 1420 may be referred to as an electronic control unit (ECU).

The controller 1420 may be configured to collect various data from the sensor 1410 connected thereto, the object detection device 1440, the communication device 1430, and the like, and may transmit a control signal based on the collected data to the sensor 1410, the engine 1306, the user interface 1308, the wireless communication device 1430, and the object detection device 1440 that are included as other components in the mobile body. Further, although not shown herein, the control signal may be also transmitted to an accelerator, a braking system, a steering device, or a navigation device related to driving of the mobile body.

According to the present embodiment, the controller 1420 may control the engine 1306, and for example, the controller 1420 may control the engine 1306 to detect a speed limit of the roadway on which the autonomous driving mobile body 1300 is driving and to prevent its driving speed from exceeding the speed limit, or may control the engine 1306 to accelerate the driving speed of the autonomous driving mobile body 1300 within a range not exceeding the speed limit.

Further, in case where the autonomous driving mobile body 1300 is approaching the lane or departing from the lane during the driving of the autonomous driving mobile body 1300, the controller 1420 may determine whether such approaching the lane or departing from the lane is due to a normal driving condition or other driving conditions, and control the engine 1306 to control the driving of the vehicle based on the result of determination. More specifically, the autonomous driving mobile body 1300 may detect lanes formed on both sides of the lane in which the vehicle is driving. In such a case, the controller 1420 may determine whether the autonomous driving mobile body 1300 is approaching the lane or departing from the lane, and if it is determined that the autonomous driving mobile body 1300 is approaching the lane or departing from the lane, then the controller 1420 may determine whether such driving is in accordance with the correct driving condition or other driving conditions. Here, an example of the normal driving condition may be a situation where it is necessary to change the lane of the mobile body. Further, an example of other driving conditions may be a situation where it is not necessary to change the lane of the mobile body. When it is determined that the autonomous driving mobile body 1300 is approaching or leaving the lane in a situation where it is not necessary for the mobile body to change the lane, the controller 1420 may control the driving of the autonomous driving mobile body 1300 such that the autonomous driving mobile body 1300 does not leave the lane and continue to drive normally in that lane.

When another mobile body or any obstruction exists in front of the mobile body, the controller may control the engine 1306 or the braking system to decelerate the mobile body, and control the trajectory, the driving route, and the steering angle of the mobile body in addition to the driving speed. Alternatively, the controller 1420 may control the driving of the mobile body by generating necessary control signals based on information collected from the external environment, such as, e.g., the driving lane of the mobile body, the driving signals, and the like.

In addition to generating its own control signals, the controller 1420 may communicate with a neighboring mobile body or a central server and transmit commands for controlling peripheral devices through the information received therefrom, thereby controlling the driving of the mobile body.

Further, when the position of the camera module 1450 changes or the angle of view changes, it may be difficult to accurately recognize the mobile body or the lane in accordance with the present embodiment, and thus the controller 1420 may generate a control signal for controlling to perform calibration of the camera module 1450 in order to prevent such a phenomenon. Accordingly, in this embodiment, the controller 1420 may generate a calibration control signal to the camera module 1450 to continuously maintain the normal mounting position, orientation, angle of view, etc. of the camera module 1450, even if the mounting position of the camera module 1450 is changed due to vibrations or impacts generated according to the movement of the autonomous driving mobile body 1300. The controller 1420 may generate a control signal to perform calibration of the camera module 1450, in case where the pre-stored initial information of mounting position, orientation, and angle of view of the camera module 1450 varies by more than a threshold value from the initial mounting position, direction, and angle of view information of the camera module 1450 measured during the driving of the autonomous driving mobile body 1300.

In this embodiment, the controller 1420 may include a memory 1422 and a processor 1424. The processor 1424 may execute software stored in the memory 1422 according to a control signal of the controller 1420. More specifically, the controller 1420 may store in the memory 1422 data and instructions for performing the lane detection method in accordance with the present disclosure, and the instructions may be executed by the processor 1424 to implement the one or more methods disclosed herein.

In such a circumstance, the memory 1422 may be included in a non-volatile recording medium executable by the processor 1424. The memory 1422 may store software and data through an appropriate internal and external device. The memory 1422 may be comprised of a random access memory (RAM), a read only memory (ROM), a hard disk, and another memory 1422 connected to a dongle.

The memory 1422 may store at least an operating system (OS), a user application, and executable instructions. The memory 1422 may also store application data, array data structures and the like.

The processor 1424 may be a microprocessor or an appropriate electronic processor, such as a controller, a microcontroller, or a state machine.

The processor 1424 may be implemented as a combination of computing devices, and the computing device may include a digital signal processor, a microprocessor, or an appropriate combination thereof.

Meanwhile, the autonomous driving mobile body 1300 may further include a user interface 1308 for a user input to the control device 1400 described above. The user interface 1308 may allow the user to input information with appropriate interaction. For example, it may be implemented as a touch screen, a keypad, a control button, etc. The user interface 1308 may transmit an input or command to the controller 1420, and the controller 1420 may perform a control operation of the mobile body in response to the input or command.

Further, the user interface 1308 may allow a device outside the autonomous driving mobile body 1300 to communicate with the autonomous driving mobile body 1300 through the wireless communication device 1430. For example, the user interface 1308 may be in association with a mobile phone, a tablet, or other computing devices.

Furthermore, this embodiment describes that the autonomous driving mobile body 1300 includes the engine 1306, but it may be also possible to include another type of propulsion system. For example, the mobile body may be operated with electrical energy or may be operable by means of hydrogen energy or a hybrid system in combination thereof. Thus, the controller 1420 may include a propulsion mechanism according to the propulsion system of the autonomous driving mobile body 1300, and may provide control signals to components of each of the propulsion mechanism accordingly.

Hereinafter, a detailed configuration of the control device 1400 according to the present embodiment will be described in more detail with reference to FIG. 14.

The control device 1400 includes a processor 1424. The processor 1424 may be a general-purpose single-chip or multi-chip microprocessor, a dedicated microprocessor, a microcontroller, a programmable gate array, or the like. The processor may be referred to as a central processing unit (CPU). In this embodiment, the processor 1424 may be implemented with a combination of a plurality of processors.

The control device 1400 also includes a memory 1422. The memory 1422 may be any electronic component capable of storing electronic information. The memory 1422 may also include a combination of memories 1422 in addition to a single memory.

Data and instructions 1422a for performing a distance measuring method of the distance measuring device according to the present disclosure may be stored in the memory 1422. When the processor 1424 executes the instructions 1422a, all or some of the instructions 1422a and the data 1422b required for executing the instructions may be loaded onto the processor 1424 (e.g., 1424a or 1424b).

The control device 1400 may include a transmitter 1430a, a receiver 1430b, or a transceiver 1430c for allowing transmission and reception of signals. The one or more antennas (1432a, 1432b) may be electrically connected to the transmitter 1430a, the receiver 1430b, or each transceiver 1430c, or may further include antennas.

The control device 1400 may include a digital signal processor (DSP) 1470. The DSP 1470 may allow the mobile body to quickly process digital signals.

The control device 1400 may include a communication interface 1480. The communication interface 1480 may include one or more ports and/or communication modules for connecting other devices to the control device 1400. The communication interface 1480 may allow the user and the control device 1400 to interact with each other.

Various components of the control device 1400 may be connected together by one or more buses 1490, and the buses 1490 may include a power bus, a control signal bus, a state signal bus, a data bus, and the like. Under the control of the processor 1424, the components may transmit information to each other via the bus 1490 and perform a desired function.

Meanwhile, in various embodiments, the control device 1400 may be related to a gateway for communication with a security cloud.

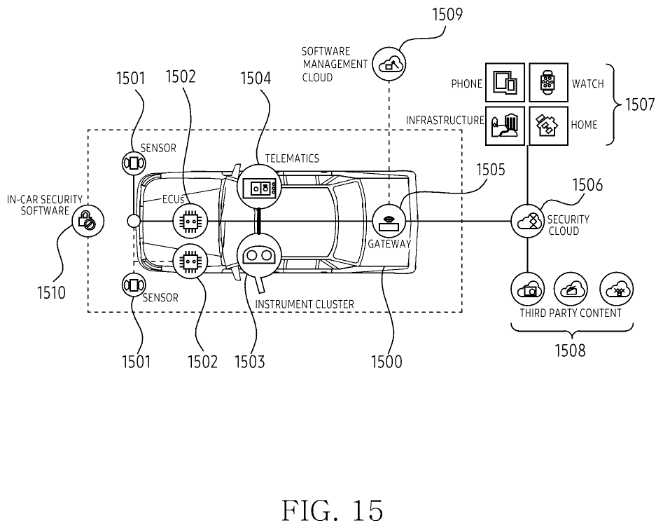

FIG. 15 illustrates an example of a gateway related to a user device according to various embodiments.

referring to FIG. 15, the control device 1400 may be related to a gateway 1505 for providing information obtained from at least one of components 1501 to 1504 of a vehicle 1500 to a security cloud 1506. For example, the gateway 1505 may be included in the control device 1400. As another example, the gateway 1505 may be configured as a separate device in the vehicle 1500 distinguished from the control device 1400. The gateway 1505 connects a software management cloud 1509 and a security cloud 1506, having different networks, with the network within the vehicle 1500 secured by in-car security software 1510, so that they can communicate with each other.

For example, a component 1501 may be a sensor. For example, the sensor may be used to obtain information about at least one of a state of the vehicle 1500 or a state around the vehicle 1500. For example, the component 1501 may include a sensor 1410.

For example, a component 1502 may be an electronic control unit (ECU). For example, the ECU may be used for engine control, transmission control, airbag control, and tire air-pressure management.

For example, a component 1503 may be an instrument cluster. For example, the instrument cluster may refer to a panel positioned in front of a driver's seat in a dashboard. For example, the instrument cluster may be configured to display information necessary for driving to the driver (or a passenger). For example, the instrument cluster may be used to display at least one of visual elements for indicating revolutions per minute (RPM) or rotations per minute of an engine, visual elements for indicating the speed of the vehicle 1500, visual elements for indicating a remaining fuel amount, visual elements for indicating a state of a transmission gear, or visual elements for indicating information obtained through the element 1501.

For example, a component 1504 may be a telematics device. For example, the telematics device may refer to an apparatus that combines wireless communication technology and global positioning system (GPS) technology to provide various mobile communication services, such as location information, safe driving or the like in the vehicle 1500. For example, the telematics device may be used to connect the vehicle 1500 with the driver, a cloud (e.g., the security cloud 1506), and/or a surrounding environment. For example, the telematics device may be configured to support a high bandwidth and a low latency, for a 5G NR standard technology (e.g., a V2X technology of 5G NR or a non-terrestrial network (NTN) technology of 5G NR). For example, the telematics device may be configured to support an autonomous driving of the vehicle 1500.

For example, the gateway 1505 may be used to connect the in-vehicle network within the vehicle 1500 with the software management cloud 1509 and the security cloud 1506, which are out-of-vehicle networks. For example, the software management cloud 1509 may be used to update or manage at least one software required for driving and managing of the vehicle 1500. For example, the software management cloud 1509 may be associated with the in-car security software 1510 installed in the vehicle. For example, the in-car security software 1510 may be used to provide a security function in the vehicle 1500. For example, the in-car security software 1510 may encrypt data transmitted and received via the in-vehicle network, using an encryption key obtained from an external authorized server for encryption of the in-vehicle network. In various embodiments, the encryption key used by the in-car security software 1510 may be generated based on the vehicle identification information (vehicle license plate, vehicle identification number (VIN)) or information uniquely assigned to each user (e.g., user identification information).

In various embodiments, the gateway 1505 may transmit data encrypted by the in-car security software 1510 based on the encryption key, to the software management cloud 1509 and/or the security cloud 1506. The software management cloud 1509 and/or the security cloud 1506 may use a decryption key capable of decrypting the data encrypted by the encryption key of the in-car security software 1510 to identify from which vehicle or user the data has been received. For example, since the decryption key is a unique key corresponding to the encryption key, the software management cloud 1509 and/or the security cloud 1506 may identify a sending entity (e.g., the vehicle or the user) of the data based on the data decrypted using the decryption key.

For example, the gateway 1505 may be configured to support the in-car security software 1510 and may be related to the control device 1400. For example, the gateway 1505 may be related to the control device 1400 to support a connection between the client device 1507 connected to the security cloud 1506 and the control device 1400. As another example, the gateway 1505 may be related to the control device 1400 to support a connection between a third party cloud 1508 connected to the security cloud 1506 and the control device 1400. However, the disclosure is not limited thereto.

In various embodiments, the gateway 1505 may be used to connect the vehicle 1500 to the software management cloud 1509 for managing the operating software of the vehicle 1500. For example, the software management cloud 1509 may monitor whether update of the operating software of the vehicle 1500 is required, and may provide data for updating the operating software of the vehicle 1500 through the gateway 1505, based on monitoring that the update of the operating software of the vehicle 1500 is required. As another example, the software management cloud 1509 may receive a user request to update the operating software of the vehicle 1500 from the vehicle 1500 via the gateway 1505 and provide data for updating the operating software of the vehicle 1500 based on the received user request. However, the disclosure is not limited thereto.

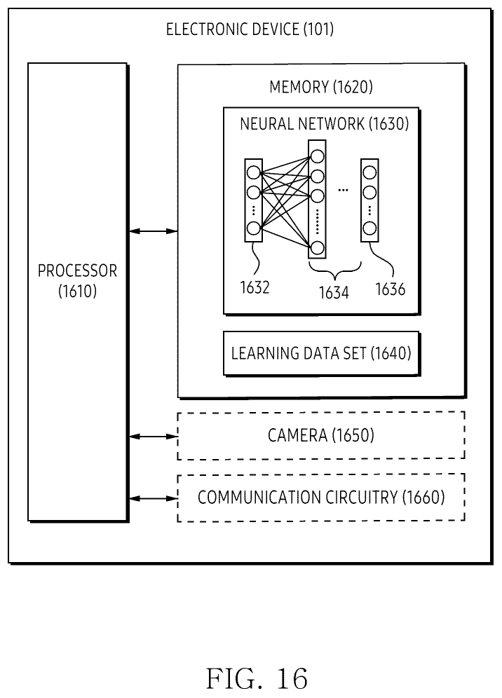

FIG. 16 is a block diagram of an electronic device according to an embodiment. The electronic device 101 of FIG. 16 may include the electronic device 101 of FIGS. 1 to 11.

Referring to FIG. 16, a processor 1610 of the electronic device 101 may perform computations related to a neural network 1630 stored in a memory 1620. The processor 1610 may include at least one of a central processing unit (CPU), a graphic processing unit (GPU), or a neural processing unit (NPU). The NPU may be implemented as a chip separated from the CPU, or may be integrated into a chip such as the CPU in the form of a system on chip (SoC). The NPU integrated in the CPU may be referred to as a neural core and/or an artificial intelligence (AI) accelerator.

Referring to FIG. 16, the processor 1610 may identify the neural network 1630 stored in the memory 1620. The neural network 1630 may include a combination of an input layer 1632, one or more hidden layers 1634 (or intermediate layers), and an output layer 1636. The above-described layers (e.g., the input layer 1632, the one or more hidden layers 1634, and the output layer 1636) may include a plurality of nodes. The number of hidden layers 1634 may vary depending on embodiments, and the neural network 1630 including a plurality of hidden layers 1634 may be referred to as a deep neural network. Operation of training the deep neural network may be referred to as deep learning.

In an embodiment, when the neural network 1630 has a structure of a feed forward neural network, a first node included in a particular layer may be connected to all of second nodes included in another prior to that particular layer. In the memory 1620, the parameters stored for the neural network 1630 may include weights assigned to connections between the second nodes and the first node. In the neural network 1630 having such a structure of feedforward neural network, a value of the first node may correspond to a weighted sum of values assigned to the second nodes, based on weights assigned to connections connecting the second nodes and the first node.

In an embodiment, when the neural network 1630 has a structure of a convolutional neural network, a first node included in a particular layer may correspond to a weighted sum of some of second nodes included in another layer prior to that particular layer. Some of the second nodes corresponding to the first node may be identified by a filter corresponding to the particular layer. In the memory 1620, the parameters stored for the neural network 1630 may include weights indicating the filter. The filter may include, among the second nodes, one or more nodes to be used to calculate a weighted sum of the first nodes, and weights corresponding to the one or more nodes, respectively.

According to an embodiment, the processor 1610 of the electronic device 101 may perform training on the neural network 1630, using the training data set 1640 stored in the memory 1620. Based on the training data set 1640, the processor 1610 may adjust one or more parameters stored in the memory 1620 for the neural network 1630.

According to an embodiment, the processor 1610 of the electronic device 101 may perform object detection, object recognition, and/or object classification, using the neural network 1630 trained based on the training data set 1640. The processor 1610 may input an image (or video) obtained through the camera 1650 to the input layer 1632 of the neural network 1630. Based on the input layer 1632 to which the image is input, the processor 1610 may sequentially obtain values of nodes of layers included in the neural network 1630 to obtain a set (e.g., output data) of values of nodes of the output layer 1636. The output data may be used based on a result of inferring information included in the image using the neural network 1630. Embodiments of the disclosure are not limited thereto, and the processor 1610 may input, to the neural network 1630, an image (or video) obtained from an external electronic device connected to the electronic device 101 through the communication circuit 1660.

In an embodiment, the neural network 1630 trained to process an image may be used to identify an area corresponding to a subject in the image (e.g., object detection) and/or identify a class of the subject represented in the image (e.g., object recognition and/or object classification). For example, the electronic device 101 may segment an area corresponding to the subject in the image, based on a rectangular shape such as e.g., a bounding box, using the neural network 1630. For example, the electronic device 101 may identify at least one class that matches the subject from among a plurality of specified classes, using the neural network 1630.

According to an embodiment, an electronic device may comprise at least one camera, a gyro sensor, memory, and at least one processor operably connected with the at least one camera, the gyro sensor, and the memory, and the processor may be configured to obtain video information by using the at least one camera, based on obtaining the video information, obtain, first rotation data on the electronic device by using the gyro sensor, and second rotation data by using a designated estimation model, based on the first rotation data and the second rotation data, obtain a rotation value for the video information, and based on the obtained rotation value, identify at least one object regarding the video information.

According to an embodiment, the at least one processor may be further configured to, based on the first rotation data and the second rotation data, obtain the rotation value for the video information by using a complementary filter.

According to an embodiment, the at least one processor may be further configured to set the video information as input data of the designated estimation model, and based on output data of the designated estimation model, obtain the second rotation data.

According to an embodiment, the at least one processor may be further configured to train the designated estimation model based on a first training video and a second training video in which the first training video is rotated according to a designated rotation value.

According to an embodiment, the at least one processor may be further configured to, based on the obtained rotation value, obtain a second video in which a first video is rotated according to the video information, identify, in the second video, the at least one object by using an object detection model, obtain a third video in which at least one bounding box for the at least one object is superimposed and displayed on the second video, and based on the third video and the obtained rotation value, obtain a fourth video in which the at least one bounding box is superimposed and displayed in the first video.

According to an embodiment, the at least one processor may be further configured to identify a first video according to the video information, identify, in the first video, the at least one object by using an object detection model, obtain a second video in which at least one bounding box for the at least one object is superimposed and displayed on the first video, and based on the obtained rotation value, obtain a third video in which the at least one bounding box in the second video is corrected and displayed.

According to an embodiment, the first rotation data may include a rotation value identified based on an axis corresponding to a direction toward which the at least one camera faces.

According to an embodiment, the electronic device may further comprise a display, and the at least one processor may be further configured to, while the first video according to the video information is displayed through the display, display, superimposed on the video, at least one bounding box for identifying the at least one object, and based on the at least one bounding box, display, superimposed on the first video, information on the at least one object.

According to an embodiment, the electronic device may be disposed in the vehicle, and the video information may be obtained by using at least one camera disposed toward a front direction of the vehicle.

According to an embodiment, the electronic device may be configured to be wearable on a body part of a user, and the video information may be obtained by using the at least one camera disposed toward a front direction of the user.

According to an embodiment, a method of an electronic device may comprise obtaining video information by using at least one camera of the electronic device, based on obtaining the video information, obtaining, first rotation data on the electronic device by using a gyro sensor of the electronic device, and second rotation data by using a designated estimation model, based on the first rotation data and the second rotation data, obtaining a rotation value for the video information, and based on the obtained rotation value, identifying at least one object regarding the video information.

According to an embodiment, the method may further comprise, based on the first rotation data and the second rotation data, obtaining the rotation value for the video information by using a complementary filter.

According to an embodiment, the method may further comprise setting the video information as input data of the designated estimation model and based on output data of the designated estimation model, obtaining the second rotation data.

According to an embodiment, the method may further comprise training the designated estimation model based on a first training video and a second training video in which the first training video is rotated according to a designated rotation value.

According to an embodiment, the method may further comprise based on the obtained rotation value, obtaining a second video in which a first video is rotated according to the video information, identifying, in the second video, the at least one object by using an object detection model, obtaining a third video in which at least one bounding box for the at least one object is superimposed and displayed on the second video, and based on the third video and the obtained rotation value, obtaining a fourth video in which the at least one bounding box is superimposed and displayed in the first video.

According to an embodiment, the method may further comprise identifying a first video according to the video information, identifying, in the first video, the at least one object by using an object detection model, obtaining a second video in which at least one bounding box for the at least one object is superimposed and displayed on the first video, and based on the obtained rotation value, obtaining a third video in which the at least one bounding box in the second video is corrected and displayed.

According to an embodiment, the first rotation data may include a rotation value identified based on an axis corresponding to a direction toward which the at least one camera faces.

According to an embodiment, the method may further comprise, while the first video according to the video information is displayed through a display of the electronic device, display, superimposed on the video, at least one bounding box for identifying the at least one object, and based on the at least one bounding box, display, superimposed on the first video, information on the at least one object.

According to an embodiment, the electronic device may be disposed in the vehicle, and the video information may be obtained by using at least one camera disposed toward a front direction of the vehicle.

According to an embodiment, the electronic device may be configured to be wearable on a body part of a user, and the video information may be obtained by using the at least one camera disposed toward a front direction of the user.

According to an embodiment, an electronic device (e.g., the electronic device 101) may identify a rotation value of the electronic device (or a vehicle) by using at least one of a gyro sensor and a designated estimation model without a high performance inertial measurement unit (IMU). The electronic device may rotate a video based on the rotation value. The electronic device may identify at least one object in the rotated video. The electronic device may set a bounding box with respect to each of the at least one object in the rotated video to match a size of the at least one object. In addition, the electronic device may be configured not only for the vehicle but also for a transportation means including a bicycle and a kickboard.

It should be appreciated that an embodiment of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

In the above-described specific embodiments of the present disclosure, a component included in the disclosure is represented in a singular or a plural according to the presented specific embodiment. However, a singular or a plural expression is selected appropriately for a situation presented for convenience of explanation and the present disclosure is not limited to a singular or a plural component, and even a component represented in a plural may be configured with a singular or even a component represented in a singular may be configured with a plural.

According to embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to embodiments, operations performed by the module, the program, or another component may be carried out sequentially, in parallel, repeatedly, or heuristically, or one or more of the operations may be executed in a different order or omitted, or one or more other operations may be added.

Meanwhile, in the detailed description of the present disclosure, the specific embodiment is described, but various modifications are, of course, possible without departing from scope of the present disclosure.

What is claimed is:

1. An electronic device comprising:
at least one camera;
a gyro sensor;
memory; and
at least one processor operably connected with the at least one camera, the gyro sensor, and the memory, and
wherein the processor is configured to:
obtain video information by using the at least one camera;
based on obtaining the video information, obtain, first rotation data on the electronic device by using the gyro sensor, and second rotation data by using a designated estimation model;
based on the first rotation data and the second rotation data, obtain a rotation value for the video information; and
based on the obtained rotation value, identify at least one object regarding the video information.

2. The electronic device of claim 1,
wherein the at least one processor is further configured to:
based on the first rotation data and the second rotation data, obtain the rotation value for the video information by using a complementary filter.

3. The electronic device of claim 1,
wherein the at least one processor is further configured to:
set the video information as input data of the designated estimation model; and
based on output data of the designated estimation model, obtain the second rotation data.

4. The electronic device of claim 1,
wherein the at least one processor is further configured to:
train the designated estimation model based on a first training video and a second training video in which the first training video is rotated according to a designated rotation value.

5. The electronic device of claim 1,
wherein the at least one processor is further configured to:
based on the obtained rotation value, obtain a second video in which a first video is rotated according to the video information;
identify, in the second video, the at least one object by using an object detection model;
obtain a third video in which at least one bounding box for the at least one object is superimposed and displayed on the second video; and
based on the third video and the obtained rotation value, obtain a fourth video in which the at least one bounding box is superimposed and displayed in the first video.

6. The electronic device of claim 1,
wherein the at least one processor is further configured to:
identify a first video according to the video information;
identify, in the first video, the at least one object by using an object detection model;
obtain a second video in which at least one bounding box for the at least one object is superimposed and displayed on the first video; and
based on the obtained rotation value, obtain a third video in which the at least one bounding box in the second video is corrected and displayed.

7. The electronic device of claim 1,
wherein the first rotation data includes a rotation value identified based on an axis corresponding to a direction toward which the at least one camera faces.

8. The electronic device of claim 1, further comprising:
a display, and
wherein the at least one processor is further configured to:
while the first video according to the video information is displayed through the display, display, superimposed on the video, at least one bounding box for identifying the at least one object; and
based on the at least one bounding box, display, superimposed on the first video, information on the at least one object.

9. The electronic device of claim 1,
wherein the electronic device is disposed in the vehicle, and
wherein the video information is obtained by using at least one camera disposed toward a front direction of the vehicle.

10. The electronic device of claim 1,
wherein the electronic device is configured to be wearable on a body part of a user, and
wherein the video information is obtained by using the at least one camera disposed toward a front direction of the user.

11. A method of an electronic device comprising:
obtaining video information by using at least one camera of the electronic device;
based on obtaining the video information, obtaining, first rotation data on the electronic device by using a gyro sensor of the electronic device, and second rotation data by using a designated estimation model;
based on the first rotation data and the second rotation data, obtaining a rotation value for the video information; and
based on the obtained rotation value, identifying at least one object regarding the video information.

12. The method of claim 11, further comprising:
based on the first rotation data and the second rotation data, obtaining the rotation value for the video information by using a complementary filter.

13. The method of claim 11, further comprising:
setting the video information as input data of the designated estimation model; and
based on output data of the designated estimation model, obtaining the second rotation data.

14. The method of claim 11, further comprising:
training the designated estimation model based on a first training video and a second training video in which the first training video is rotated according to a designated rotation value.

15. The method of claim 11, further comprising:
based on the obtained rotation value, obtaining a second video in which a first video is rotated according to the video information;
identifying, in the second video, the at least one object by using an object detection model;
obtaining a third video in which at least one bounding box for the at least one object is superimposed and displayed on the second video; and
based on the third video and the obtained rotation value, obtaining a fourth video in which the at least one bounding box is superimposed and displayed in the first video.

16. The method of claim 11, further comprising:
identifying a first video according to the video information;
identifying, in the first video, the at least one object by using an object detection model;
obtaining a second video in which at least one bounding box for the at least one object is superimposed and displayed on the first video; and
based on the obtained rotation value, obtaining a third video in which the at least one bounding box in the second video is corrected and displayed.

17. The method of claim 11,
wherein the first rotation data includes a rotation value identified based on an axis corresponding to a direction toward which the at least one camera faces.

18. The method of claim 11, further comprising:
while the first video according to the video information is displayed through a display of the electronic device, display, superimposed on the video, at least one bounding box for identifying the at least one object; and
based on the at least one bounding box, display, superimposed on the first video, information on the at least one object.

19. The method of claim 11,
wherein the electronic device is disposed in the vehicle, and
wherein the video information is obtained by using at least one camera disposed toward a front direction of the vehicle.

20. The method of claim 11,
wherein the electronic device is configured to be wearable on a body part of a user, and
wherein the video information is obtained by using the at least one camera disposed to ward a front direction of the user.
